(19) United States
(12) Patent Application Publication
(10) Pub. No.: US 2026/0283157 A1
(43) Pub. Date: Sep. 24, 2026

(54) IODOPHOR FORMULATION AND METHOD OF MAKING AND USING THEREOF

(71) Applicant: EcoLab Innovations, Sheridan, WY (US)

(72) Inventors: Ricardo Emilio Flores Cuellar, San Salvador (SV); Raul Alfonso Jovel Suncin, San Salvador (SV)

(21) Appl. No.: 19/083,107

(22) Filed: Mar. 18, 2025

(51) Int. Cl. A01N 59/12; C05D 9/02

(52) U.S. Cl. CPC A01N 59/12; C05D 9/02

(57) ABSTRACT

The present disclosure is directed to an iodophor formulation, method of making the iodophor formulation, and method of using the iodophor formulation. The iodophor composition comprises an iodine mixture, a nonionic surfactant, a macronutrient, a chelated micronutrient, and an agriculturally acceptable liquid carrier or diluent.

### BACKGROUND

Enhancing agricultural productivity remains a critical challenge in modern farming, as increasing demand for food requires sustainable and efficient solutions. Traditional fertilizers primarily supply macronutrients to address soil nutrient deficiencies but often fail to support the full physiological potential of plants, especially under environmental stresses.

Iodophor formulations, widely used as antimicrobial agents, have shown secondary benefits on plant physiology, including increased root mass and improved nutrient uptake. However, their potential in agriculture has been limited due to the absence of a complementary nutritional profile and insufficient focus on their role in promoting plant growth and resilience.

### BRIEF SUMMARY

Provided herein is an iodophor formulation. The iodophor formulation comprises an iodine mixture, a nonionic surfactant, a macronutrient, a chelated micronutrient, and an agriculturally acceptable liquid carrier or diluent.

Further provided herein is a method of preparing an iodophor formulation. The method comprises dissolving a micronutrient and a chelated micronutrient in water to prepare a nutrient solution, dissolving potassium iodide in water and adding iodine to the potassium iodide in the water to prepare an iodine mixture, adding a nonionic surfactant to the nutrient solution forming a nonionic surfactant nutrient solution, and combining the nonionic surfactant nutrient solution and the iodine mixture to form the iodophor formulation.

Further provided herein is a method of increasing photosynthetic efficiency of a crop. The method comprises treating the crop with the iodophor formulation comprising an iodine mixture, a nonionic surfactant, a macronutrient, a chelated micronutrient, and an agriculturally acceptable liquid carrier or diluent.

Further provided herein is a method of promoting development of a root and leaf. The method comprises treating the root and leaf with the iodophor formulation comprising an iodine mixture, a nonionic surfactant, a macronutrient, a chelated micronutrient, and an agriculturally acceptable liquid carrier or diluent.

Further provided herein is a method of improving yield of a crop. The method comprises treating the crop with the iodophor formulation comprising an iodine mixture, a nonionic surfactant, a macronutrient, a chelated micronutrient, and an agriculturally acceptable liquid carrier or diluent.

### DETAILED DESCRIPTION

The present disclosure relates to iodophor formulations, methods of making the iodophor formulations, and methods of using the iodophor formulations.

It is to be understood that both the foregoing general description and the following detailed description are exemplary and explanatory only and are not restrictive of the invention claimed. As used herein, the use of the singular includes the plural unless specifically stated otherwise. The section headings used herein are for organizational purposes only and are not to be construed as limiting the subject matter described.

As used herein, “or” means “and/or” unless stated otherwise. Furthermore, use of the term “including” as well as other forms, such as “includes” and “included,” is not limiting.

As used herein, “about” means that a number referred to as “about” comprises the recited number plus or minus 1-10% of that recited number. For example, “about” 100 degrees can mean 95-105 degrees or as few as 99-101 degrees depending on the context.

As used herein, the term “macronutrient” refers to essential elements plants/crops need in large quantities to grow and thrive. These nutrients are crucial for various functions like energy production, structural support, and overall health. Examples of macronutrients for plants include but are not limited to nitrogen, phosphorous, potassium, calcium, magnesium, and sulfur.

The term “crop” herein is intended to mean any plant, such as a cane, vine, shrub, bush, tree or any other plant in general. Examples of crops as discussed herein can include a fruit, a grain, a vegetable, a coffee tree, a citrus tree, or a combination thereof.

As used herein, the term “chelated micronutrient” refers to a mineral that is bound to an organic molecule, called a chelate, to make it more available and easier for plants or animals to absorb. The chelation process helps protect the mineral from interacting with other compounds in the environment that might make it unavailable or less effective. Examples of chelated micronutrients include but are not limited to metals iron, copper, zinc, or manganese.

As used herein, the term “humectant” refers to a substance that attracts and retains moisture.

As used herein, the term “amphoteric surfactant” refers to a type of surfactant that can act as both a cationic and an anionic agent, depending on the pH of the solution. This dual charge capability gives amphoteric surfactants flexibility in a variety of formulations.

As used herein, the term “stabilized iodine” refers to iodine that has undergone a complexation reaction. An example of a complexation reaction is the reaction between elemental iodine and an iodide salt. An example of stabilized iodine is triiodide ion. Iodine is stabilized to increase iodine solubility, prevent volatilization, and ensure a controlled but sustained release of iodine for proper plant absorption.

As used herein, the term “nutrient compatibility” refers to the ability to maintain an ideal pH to ensure all ingredients in a formulation are properly available and capable of being absorbed by a plant.

As used herein, the term “nutrient solution” refers to a solution that includes one or more micronutrients, one or more macronutrients, or a combination thereof.

### Iodophor Formulation

The iodophor formulation may include an iodine mixture, a nonionic surfactant, a macronutrient, a micronutrient, and an agriculturally acceptable liquid carrier or diluent. The iodophor formulation may further include an additive. The additive may be a humectant, wetting agent, adjuvant, an amphoteric surfactant, citric acid, sodium citrate, or a combination thereof. The micronutrient may be a chelated micronutrient.

The iodine mixture comprises a stabilized iodine such as a triiodide ion (I₃⁻) or an organic acid-complexed iodine. The triiodide ion (I₃⁻) may be formed by reacting elemental iodine (I₂) with a suitable iodide salt. Elemental iodine may act as an active antimicrobial agent. Suitable iodide salts include but are not limited to sodium iodine (NaI), calcium iodine (CaI₂), potassium iodine (KI), magnesium iodide (MgI₂), or lithium iodide. The stabilized iodine may also be formed by reacting elemental iodine with an organic acid to form an organic acid-complexed iodine. Suitable organic acids include but are not limited to citric acid, lactic acid, malic acid, tartaric acid, acetic acid, fumaric acid, ascorbic acid, or any combination thereof.

The amount of organic acid needed to stabilize the iodine may be more than the amount of iodide salt. For example, the amount of organic acid needed may be about 10% to about 50% greater than the amount of iodide salt needed. In some embodiments, the amount of organic acid needed may be about 10% to about 50%, about 11% to about 50%, about 12% to about 50%, about 13% to about 50%, about 14% to about 50%, about 15% to about 50%, about 16% to about 50%, about 17% to about 50%, about 18% to about 50%, about 19% to about 50%, about 20% to about 50%, about 21% to about 50%, about 22% to about 50%, about 23% to about 50%, about 24% to about 50%, about 25% to about 50%, about 26% to about 50%, about 27% to about 50%, about 28% to about 50%, about 29% to about 50%, about 30% to about 50%, about 31% to about 50%, about 32% to about 50%, about 33% to about 50%, about 34% to about 50%, about 35% to about 50%, about 36% to about 50%, about 37% to about 50%, about 38% to about 50%, about 39% to about 50%, about 40% to about 50%, about 41% to about 50%, about 42% to about 50%, about 43% to about 50%, about 44% to about 50%, about 45% to about 50%, about 46% to about 50%, about 47% to about 50%, about 48% to about 50%, about 49% to about 50%, about 10% to about 40%, about 11% to about 39%, about 12% to about 38%, about 13% to about 37%, about 14% to about 36%, about 15% to about 35%, about 16% to about 34%, about 17% to about 33%, about 18% to about 32%, about 19% to about 31%, or about 20% to about 30% greater than the amount of iodide salt needed. In some embodiments, the amount of organic acid needed may be about 10% to about 11%, about 10% to about 12%, about 10% to about 13%, about 10% to about 14%, about 10% to about 15%, about 10% to about 16%, about 10% to about 17%, about 10% to about 18%, about 10% to about 19%, about 10% to about 20%, 10% to about 21%, about 10% to about 22%, about 10% to about 23%, about 10% to about 24%, about 10% to about 25%, about 10% to about 26%, about 10% to about 27%, about 10% to about 28%, about 10% to about 29%, about 10% to about 30%, 10% to about 31%, about 10% to about 32%, about 10% to about 33%, about 10% to about 34%, about 10% to about 35%, about 10% to about 36%, about 10% to about 37%, about 10% to about 38%, about 10% to about 39%, about 10% to about 40%, 10% to about 41%, about 10% to about 42%, about 10% to about 43%, about 10% to about 44%, about 10% to about 45%, about 10% to about 46%, about 10% to about 47%, about 10% to about 48%, about 10% to about 49%, or about 10% to about 50% greater than the amount of iodide salt needed. In some embodiments, the amount of organic acid needed may be about 20% to about 50% greater than the amount of iodide salt needed.

The elemental iodine and the iodide salt may be present in a weight ratio (I₂:iodide salt) from about 0.5:1 to about 2:1. For example, the ratio may be from about 0.5:1 to about 2:1, about 0.6:1 to about 2:1, about 0.7:1 to about 2:1, about 0.8:1 to about 2:1, about 0.9:1 to about 2:1, about 1:1 to about 2:1, about 1.1:1 to about 2:1, about 1.2:1 to about 2:1, about 1:3 to about 2:1, about 1:4 to about 2:1, about 1.5:1 to about 2:1, about 1.6:1 to about 2:1, about 1.7:1 to about 2:1, about 1.8:1 to about 2:1, about 1.9:1 to about 2:1, about 0.5:1 to about 1:1, about 0.7:1 to about 1:1, about 0.9:1 to about 1:1, about 1:1 to about 1.2:1, about 1.4:1 to about 1.6:1, or about 1.5:1 to about 1.9:1. In some embodiments, the elemental iodine and the iodide salt may present in a weight ratio may be about 0.5:1 to about 0.6:1, about 0.5:1 to about 0.7:1, about 0.5:1 to about 0.8:1, about 0.5:1 to about 0.9:1, about 0.5:1 to about 1:1, about 0.5:1 to about 1.1:1, about 0.5:1 to about 1.2:1, about 0.5:1 to about 1.3:1, about 0.5:1 to about 1.4:1, about 0.5:1 to about 1.5:1, about 0.5:1 to about 1.6:1, about 0.5:1 to about 1.7:1, about 0.5:1 to about 1.8:1, about 0.5:1 to about 1.9:1, or about 0.5:1 to about 2:1. In some embodiments, the elemental iodine and the iodide salt may present in a weight ratio may be 0.9:1.

In some embodiments, the iodide salt may be potassium iodide (KI). In some embodiments, the elemental iodine and the potassium iodide may be present in a weight ratio (I₂:KI) from about 0.5:1 to about 2:1, about 0.6:1 to about 2:1, about 0.7:1 to about 2:1, about 0.8:1 to about 2:1, about 0.9:1 to about 2:1, about 1:1 to about 2:1, about 1.1:1 to about 2:1, about 1.2:1 to about 2:1, about 1:3 to about 2:1, about 1:4 to about 2:1, about 1.5:1 to about 2:1, about 1.6:1 to about 2:1, about 1.7:1 to about 2:1, or about 1.8:1 to about 2:1, about 1.9:1 to about 2:1, about 0.5:1 to about 1:1, about 0.7:1 to about 1:1, about 0.9:1 to about 1:1, about 1:1 to about 1.2:1, about 1.4:1 to about 1.6:1, or about 1.5:1 to about 1.9:1. In some embodiments, the elemental iodine and the potassium iodide may present in a weight ratio may be 0.9:1.

The iodine mixture may be present in the iodophor formulation in an amount from 0.1% to 5% by weight. For example, the iodine mixture may be present in the iodophor formulation in an amount from about 0.1% to about 5%, about 0.2% to about 5%, about 0.3% to about 5%, about 0.4% to about 5%, about 0.5% to about 5%, about 0.6% to about 5%, about 0.7% to about 5%, about 0.8% to about 5%, about 0.9% to about 5%, about 1.0% to about 5%, about 1.1% to about 5%, about 1.2% to about 5%, about 1.3% to about 5%, about 1.4% to about 5%, about 1.5% to about 5%, about 1.6% to about 5%, about 1.7% to about 5%, about 1.8% to about 5%, about 1.9% to about 5%, about 2.0% to about 5%, about 2.1% to about 5%, about 2.2% to about 5%, about 2.3% to about 5%, about 2.4% to about 5%, about 2.5% to about 5%, about 2.6% to about 5%, about 2.7% to about 5%, about 2.8% to about 5%, about 2.9% to about 5%, about 3.0% to about 5%, about 3.1% to about 5%, about 3.2% to about 5%, about 3.3% to about 5%, about 3.4% to about 5%, about 3.5% to about 5%, about 3.6% to about 5%, about 3.7% to about 5%, about 3.8% to about 5%, about 3.9% to about 5%, about 4.0% to about 5%, about 4.1% to about 5%, about 4.2% to about 5%, about 4.3% to about 5%, about 4.4% to about 5%, about 4.5% to about 5%, about 4.6% to about 5%, about 4.7% to about 5%, about 4.8% to about 5%, or about 4.9% to about 5% by weight of the iodophor formulation. In some embodiments, the iodine mixture may be present in the iodophor formulation in an amount from about 0.5% to about 2%, about 0.6% to about 2%, about 0.7% to about 2%, about 0.8% to about 2%, about 0.9% to about 2%, about 1.0% to about 2%, about 1.1% to about 2%, about 1.2% to about 2%, about 1.3% to about 2%, about 1.4% to about 2%, about 1.5% to about 2%, about 1.6% to about 2%, about 1.7% to about 2%, about 1.8% to about 2%, or about 1.9% to about 2% by weight of the iodophor formulation. In some embodiments, the iodine mixture may be present in the iodophor formulation in an amount from about 0.1% to about 0.2%, about 0.1% to about 0.3%, about 0.1% to about 0.4%, about 0.1% to about 0.5%, about 0.1% to about 0.6%, about 0.1% to about 0.7%, about 0.1% to about 0.8%, about 0.1% to about 0.9%, about 0.1% to about 1.0%, about 0.1% to about 1.1%, about 0.1% to about 1.2%, about 0.1% to about 1.3%, about 0.1% to about 1.4%, about 0.1% to about 1.5%, about 0.1% to about 1.6%, about 0.1% to about 1.7%, about 0.1% to about 1.8%, about 0.1% to about 1.9%, about 0.1% to about 2.0%, about 0.1% to about 2.1%, about 0.1% to about 2.2%, about 0.1% to about 2.3%, about 0.1% to about 2.4%, about 0.1% to about 2.5%, about 0.1% to about 2.6%, about 0.1% to about 2.7%, about 0.1% to about 2.8%, about 0.1% to about 2.9%, about 0.1% to about 3.0%, about 0.1% to about 3.1%, about 0.1% to about 3.2%, about 0.1% to about 3.3%, about 0.1% to about 3.4%, about 0.1% to about 3.5%, about 0.1% to about 3.6%, about 0.1% to about 3.7%, about 0.1% to about 3.8%, about 0.1% to about 3.9%, about 0.1% to about 4.0%, about 0.1% to about 4.1%, about 0.1% to about 4.2%, about 0.1% to about 4.3%, about 0.1% to about 4.4%, about 0.1% to about 4.5%, about 0.1% to about 4.6%, about 0.1% to about 4.7%, about 0.1% to about 4.8%, about 0.1% to about 4.9%, or about 0.1% to about 5.0% by weight of the iodophor formulation. In some embodiments, the iodine mixture may be present in the iodophor formulation in an amount from about 0.1% to about 5%, about 0.5% to about 4.5%, about 1% to about 4%, about 1.5% to about 3.5%, about 2% to about 3%, about 0.5% to about 1%, about 0.75% to about 1.25%, about 1.0% to about 1.5%, or about 1.5% to about 2% by weight of the iodophor formulation.

The nonionic surfactant may be polyethylene glycol (PEG)-based, fatty acid ester-based, polyoxyethylene (POE)-based, sorbitan derivative-based, amine oxide-based, sugar-based, or any combinations thereof. An example of a polyethylene glycol (PEG)-based surfactant includes Triton X-100. An example of a fatty acid ester-based surfactant includes sorbitan monolaurate. An example of a polyoxyethylene (POE)-based includes polyoxyethylene (23) lauryl ether. Examples of sorbitan derivative-based nonionic surfactant include polyoxyethylene sorbitan ester. Polyoxyethylene sorbitan esters include but are not limited to polyoxyethylene (20) sorbitan monooleate (also known as polysorbate 20 or Tween 20), polyoxyethylene (40) sorbitan monooleate (also known as polysorbate 40 or Tween 40), polyoxyethylene (60) sorbitan monooleate (also known as polysorbate 60 or Tween 60), polyoxyethylene (65) sorbitan monooleate (also known as polysorbate 65 or Tween 65), polyoxyethylene (80) sorbitan monooleate (also known as polysorbate 80 or Tween 80), or polyoxyethylene (120) sorbitan monooleate (also known as polysorbate 120 or Tween 120). In some embodiments, the sorbitan derivative-based nonionic surfactant may be polyoxyethylene (80) sorbitan monooleate. An example of an amine oxide-based includes cocamidopropyl betaine. Examples of sugar-based surfactants include but are not limited to sucrose esters or alkyl polyglucosides (APGs). In some embodiments, the nonionic surfactant may be an alkyl polyglucoside, an alcohol ethoxylate, a nonylphenol ethoxylate, a polyoxyethylene sorbitan ester, a silicon based nonionic surfactant, a betaine, or any combination thereof. The silicon based nonionic surfactant includes but is not limited to Silwet L-77 or Break-Thru S240. The betaine includes but is not limited to cocamidopropyl betaine.

The alkyl polyglucoside may include, but is not limited to, sunflower glucoside, coco-glucoside, decyl glucoside, lauryl glucoside, capryl glucoside, or a combination thereof.

The alcohol ethoxylate may have from 1 to 50 ethylene oxide units. For example, the number of ethylene oxide units may be from about 1 to about 50, about 5 to about 45, about 10 to about 40, about 15 to about 35, about 20 to about 30, or about 22 to about 27. In some embodiments, the number of ethylene oxide units may be from about 4 to about 30, about 5 to about 30, about 6 to about 30, about 7 to about 30, about 8 to about 30, about 9 to about 30, about 10 to about 30, about 11 to about 30, about 12 to about 30, about 13 to about 30, about 14 to about 30, about 15 to about 30, about 16 to about 30, about 17 to about 30, about 18 to about 30, about 19 to about 30, about 20 to about 30, about 21 to about 30, about 22 to about 30, about 23 to about 30, about 24 to about 30, about 25 to about 30, about 26 to about 30, about 27 to about 30, about 28 to about 30, about 29 to about 30. The number of ethylene oxide units be from about 5 to about 25, about 10 to about 20, or about 14 to about 17.

The nonylphenol ethoxylate may have from 1 to 50 ethylene oxide units. For example, the number of ethylene oxide units may be from about 1 to about 50, about 5 to about 45, about 10 to about 40, about 15 to about 35, about 20 to about 30, or about 22 to about 27. In some embodiments, the number of ethylene oxide units may be from about 4 to about 30, about 5 to about 30, about 6 to about 30, about 7 to about 30, about 8 to about 30, about 9 to about 30, about 10 to about 30, about 11 to about 30, about 12 to about 30, about 13 to about 30, about 14 to about 30, about 15 to about 30, about 16 to about 30, about 17 to about 30, about 18 to about 30, about 19 to about 30, about 20 to about 30, about 21 to about 30, about 22 to about 30, about 23 to about 30, about 24 to about 30, about 25 to about 30, about 26 to about 30, about 27 to about 30, about 28 to about 30, about 29 to about 30. The number of ethylene oxide units be from about 5 to about 25, about 10 to about 20, or about 14 to about 17.

When biodegradability may be a priority, the nonionic surfactant used may be alkyl polyglucosides (APGs), which may be derived from renewable plant-based sources and are highly biodegradable. Preferably, sunflower glucoside may be utilized due to its excellent environmental profile and effectiveness in agricultural applications. Additional biodegradable additives, such as glycerin, betaine derived from coconut (cocamidopropyl betaine), monosilicic acid and similar compounds may be included to enhance formulation stability, improve performance, or provide complementary benefits to the primary formulation.

The nonionic surfactant and the iodine mixture may be present in a weight ratio from about 1:1 to 50:1. For example, the weight ratio may be from about 1:1 to about 50:1, about 2:1 to about 50:1, about 3:1 to about 50:1, about 4:1 to about 50:1, about 5:1 to about 50:1, about 6:1 to about 50:1, about 7:1 to about 50:1, about 8:1 to about 50:1, about 9:1 to about 50:1, about 10:1 to about 50:1, about 11:1 to about 50:1, about 12:1 to about 50:1, about 13:1 to about 50:1, about 14:1 to about 50:1, about 15:1 to about 50:1, about 16:1 to about 50:1, about 17:1 to about 50:1, about 18:1 to about 50:1, about 19:1 to about 50:1, about 20:1 to about 50:1, about 21:1 to about 50:1, about 22:1 to about 50:1, about 23:1 to about 50:1, about 24:1 to about 50:1, about 25:1 to about 50:1, about 26:1 to about 50:1, about 27:1 to about 50:1, about 28:1 to about 50:1, about 29:1 to about 50:1, about 30:1 to about 50:1, about 31:1 to about 50:1, about 32:1 to about 50:1, about 33:1 to about 50:1, about 34:1 to about 50:1, about 35:1 to about 50:1, about 36:1 to about 50:1, about 37:1 to about 50:1, about 38:1 to about 50:1, about 39:1 to about 50:1, about 40:1 to about 50:1, about 41:1 to about 50:1, about 42:1 to about 50:1, about 43:1 to about 50:1, about 44:1 to about 50:1, about 45:1 to about 50:1, about 46:1 to about 50:1, about 47:1 to about 50:1, about 48:1 to about 50:1, about 49:1 to about 50:1. In some embodiments, the weight ratio may be from about 3:1 to about 40:1, 4:1 to about 40:1, about 5:1 to about 40:1, about 6:1 to about 40:1, about 7:1 to about 40:1, about 8:1 to about 40:1, about 9:1 to about 40:1, about 10:1 to about 40:1, about 11:1 to about 40:1, about 12:1 to about 40:1, about 13:1 to about 40:1, about 14:1 to about 40:1, about 15:1 to about 40:1, about 16:1 to about 40:1, about 17:1 to about 40:1, about 18:1 to about 40:1, about 19:1 to about 40:1, about 20:1 to about 40:1, about 21:1 to about 40:1, about 22:1 to about 40:1, about 23:1 to about 40:1, about 24:1 to about 40:1, about 25:1 to about 40:1, about 26:1 to about 40:1, about 27:1 to about 40:1, about 28:1 to about 40:1, about 29:1 to about 40:1, about 30:1 to about 40:1, about 31:1 to about 40:1, about 32:1 to about 40:1, about 33:1 to about 40:1, about 34:1 to about 40:1, about 35:1 to about 40:1, about 36:1 to about 40:1, about 37:1 to about 40:1, about 38:1 to about 40:1, or about 39:1 to about 40:1. In some embodiments, the weight ratio of the nonionic surfactant and the iodine mixture may be 20:1. In some embodiments, the weight ratio of the nonionic surfactant and the iodine mixture may be from 3:1 to 40:1.

The nonionic surfactant may be present in the iodophor formulation in an amount from 5% to 25% by weight. For example, the nonionic surfactant may be present in the iodophor formulation in an amount from about 5% to about 25%, about 6% to about 25%, about 7% to about 25%, about 8% to about 25%, about 9% to about 25%, about 10% to about 25%, about 11% to about 25%, about 12% to about 25%, about 13% to about 25%, about 14% to about 25%, about 15% to about 25%, about 16% to about 25%, about 17% to about 25%, about 18% to about 25%, about 19% to about 25%, about 20% to about 25%, about 21% to about 25%, about 22% to about 25%, about 23% to about 25%, or about 24% to about 25% by weight. In some embodiments, the nonionic surfactant may be present in the iodophor formulation in an amount from about 5% to about 6%, about 5% to about 7%, about 5% to about 8%, about 5% to about 9%, about 5% to about 10%, about 5% to about 11%, about 5% to about 12%, about 5% to about 13%, about 5% to about 14%, about 5% to about 15%, about 5% to about 16%, about 5% to about 17%, about 5% to about 18%, about 5% to about 19%, about 5% to about 20%, about 5% to about 21%, about 5% to about 22%, about 5% to about 23%, about 5% to about 24%, or about 5% to about 25% by weight. In some embodiments, the nonionic surfactant may be present in the iodophor formulation in an amount from about 10% to about 25%, about 10% to about 20%, about 10% to about 15%, about 5% to about 25%, about 5% to about 20%, about 5% to about 15%, about 5% to about 10%, about 5% to about 15%, about 6% to about 14%, about 7% to about 10%, or about 8% to about 9%. In some embodiments, the nonionic surfactant may be present in the iodophor formulation at about 11% by weight.

The macronutrient may include magnesium, calcium, nitrogen, diphosphorous pentoxide (P₂O₅), potassium oxide (K₂O), or a combination thereof. Nitrogen may promote vegetative growth and the development of larger leaves for enhanced photosynthesis. Diphosphorous pentoxide may encourage robust root system development. Potassium oxide may improve plant metabolism and crop quality. Magnesium may improve plant resilience to stress, enhance nutrient absorption, and promote overall growth. Calcium may strengthen cell structure, promote growth, and help plants adapt to environmental conditions.

The macronutrient may be present in the iodophor formulation in an amount from 1% to 40% by weight. For example, the macronutrients may be present in the iodophor formulation in an amount from about 1% to about 40%, about 2% to about 40%, about 3% to about 40%, about 4% to about 40%, about 5% to about 40%, about 6% to about 40%, about 7% to about 40%, about 8% to about 40%, about 9% to about 40%, about 10% to about 40%, about 11% to about 40%, about 12% to about 40%, about 13% to about 40%, about 14% to about 40%, about 15% to about 40%, about 16% to about 40%, about 17% to about 40%, about 18% to about 40%, about 19% to about 40%, about 20% to about 40%, about 21% to about 40%, about 22% to about 40%, about 23% to about 40%, about 24% to about 40%, about 25% to about 40%, about 26% to about 40%, about 27% to about 40%, about 28% to about 40%, about 29% to about 40%, about 30% to about 40%, about 31% to about 40%, about 32% to about 40%, about 33% to about 40%, about 34% to about 40%, about 35% to about 40%, about 36% to about 40%, about 37% to about 40%, about 38% to about 40%, or about 39% to about 40% by weight of the iodophor formulation. In some embodiments, the macronutrient may be present in the iodophor formulation in an amount from about 1% to about 2%, about 1% to about 3%, about 1% to about 4%, about 1% to about 5%, about 1% to about 6%, about 1% to about 7%, about 1% to about 8%, about 1% to about 9%, about 1% to about 10%, about 1% to about 11%, about 1% to about 12%, about 1% to about 13%, about 1% to about 14%, about 1% to about 15%, about 1% to about 16%, about 1% to about 17%, about 1% to about 18%, about 1% to about 19%, about 1% to about 10%, about 1% to about 11%, about 1% to about 12%, about 1% to about 13%, about 1% to about 14%, about 1% to about 15%, about 1% to about 16%, about 1% to about 17%, about 1% to about 18%, about 1% to about 19%, about 1% to about 20%, about 1% to about 21%, about 1% to about 22%, about 1% to about 23%, about 1% to about 24%, about 1% to about 25%, about 1% to about 26%, about 1% to about 27%, about 1% to about 28%, about 1% to about 29%, about 1% to about 30%, about 1% to about 31%, about 1% to about 32%, about 1% to about 33%, about 1% to about 34%, about 1% to about 35%, about 1% to about 36%, about 1% to about 37%, about 1% to about 38%, about 1% to about 39%, or about 1% to about 40% by weight of the iodophor formulation. In some embodiments, the macronutrient may be present in the iodophor formulation in an amount from about 5% to about 35%, about 10% to about 30%, about 15% to about 25%, about 20% to about 22%, about 1% to about 5%, about 5% to about 10%, about 15% to about 25%, about 17% to about 23%, or about 20% to about 21% by weight of the iodophor formulation.

In some embodiments, the macronutrient may include nitrogen.

The micronutrient may include manganese, iron, zinc, copper, boron, molybdenum, or a combination thereof. The micronutrient may include a chelated micronutrient comprising a micronutrient and a chelating agent. The chelated micronutrient may include manganese, iron, zinc, copper, or a combination thereof. The chelating agent may include an organic acid. Examples of organic acid chelating agents include, but are not limited to, amino acids, humic acids, fulvic acids, gluconic acid, and citric acid. Examples of synthetic chelating agents include but are not limited to EDTA and DTPA.

The micronutrient may be present in the iodophor formulation in an amount from 0.0001% to 5% by weight of the iodophor formulation. For example, the micronutrient may be present in the iodophor formulation in an amount from about 0.0001% to about 5.0%, about 0.0002% to about 5.0%, about 0.0003% to about 5.0%, about 0.0004% to about 5.0%, about 0.0005% to about 5.0%, about 0.0006% to about 5.0%, about 0.0007% to about 5.0%, about 0.0008% to about 5.0%, about 0.0009% to about 5.0%, about 0.001% to about 5.0%, about 0.002% to about 5.0%, about 0.003% to about 5.0%, about 0.004% to about 5.0%, about 0.005% to about 5.0%, about 0.006% to about 5.0%, about 0.007% to about 5.0%, about 0.008% to about 5.0%, about 0.009% to about 5.0%, about 0.01% to about 5.0%, about 0.02% to about 5.0%, about 0.03% to about 5.0%, about 0.04% to about 5.0%, about 0.05% to about 5.0%, about 0.06% to about 5.0%, about 0.07% to about 5.0%, about 0.08% to about 5.0%, about 0.09% to about 5.0%, about 0.1% to about 5.0%, about 0.2% to about 5.0%, about 0.3% to about 5.0%, about 0.4% to about 5.0%, about 0.5% to about 5.0%, about 0.6% to about 5.0%, about 0.7% to about 5.0%, about 0.8% to about 5.0%, about 0.9% to about 5.0%, about 1.0% to about 5.0%, about 2.0% to about 5.0%, about 3.0% to about 5.0%, about 4.0% to about 5.0%, about 0.0001% to about 4.0%, about 0.0002% to about 4.0%, about 0.0003% to about 4.0%, about 0.0004% to about 4.0%, about 0.0005% to about 4.0%, about 0.0006% to about 4.0%, about 0.0007% to about 4.0%, about 0.0008% to about 4.0%, about 0.0009% to about 4.0%, about 0.001% to about 4.0%, about 0.002% to about 4.0%, about 0.003% to about 4.0%, about 0.004% to about 4.0%, about 0.005% to about 4.0%, about 0.006% to about 4.0%, about 0.007% to about 4.0%, about 0.008% to about 4.0%, about 0.009% to about 4.0%, about 0.01% to about 4.0%, about 0.02% to about 4.0%, about 0.03% to about 4.0%, about 0.04% to about 4.0%, about 0.05% to about 4.0%, about 0.06% to about 4.0%, about 0.07% to about 4.0%, about 0.08% to about 4.0%, about 0.09% to about 4.0%, about 0.1% to about 4.0%, about 0.2% to about 4.0%, about 0.3% to about 4.0%, about 0.4% to about 4.0%, about 0.5% to about 4.0%, about 0.6% to about 4.0%, about 0.7% to about 4.0%, about 0.8% to about 4.0%, about 0.9% to about 4.0%, about 0.0001% to about 1.0%, about 0.0002% to about 1.0%, about 0.0003% to about 1.0%, about 0.0004% to about 1.0%, about 0.0005% to about 1.0%, about 0.0006% to about 1.0%, about 0.0007% to about 1.0%, about 0.0008% to about 1.0%, about 0.0009% to about 1.0%, about 0.001% to about 1.0%, about 0.002% to about 1.0%, about 0.003% to about 1.0%, about 0.004% to about 1.0%, about 0.005% to about 1.0%, about 0.006% to about 1.0%, about 0.007% to about 1.0%, about 0.008% to about 1.0%, about 0.009% to about 1.0%, about 0.01% to about 1.0%, about 0.02% to about 1.0%, about 0.03% to about 1.0%, about 0.04% to about 1.0%, about 0.05% to about 1.0%, about 0.06% to about 1.0%, about 0.07% to about 1.0%, about 0.08% to about 1.0%, about 0.09% to about 1.0%, about 0.1% to about 1.0%, about 0.2% to about 1.0%, about 0.3% to about 1.0%, about 0.4% to about 1.0%, about 0.5% to about 1.0%, about 0.6% to about 1.0%, about 0.7% to about 1.0%, about 0.8% to about 1.0%, about 0.9% to about 1.0%, about 0.0001% to about 0.9%, about 0.0002% to about 0.9%, about 0.0003% to about 0.9%, about 0.0004% to about 0.9%, about 0.0005% to about 0.9%, about 0.0006% to about 0.9%, about 0.0007% to about 0.9%, about 0.0008% to about 0.9%, about 0.0009% to about 0.9%, about 0.001% to about 0.9%, about 0.002% to about 0.9%, about 0.003% to about 0.9%, about 0.004% to about 0.9%, about 0.005% to about 0.9%, about 0.006% to about 0.9%, about 0.007% to about 0.9%, about 0.008% to about 0.9%, about 0.009% to about 0.9%, about 0.01% to about 0.9%, about 0.02% to about 0.9%, about 0.03% to about 0.9%, about 0.04% to about 0.9%, about 0.05% to about 0.9%, about 0.06% to about 0.9%, about 0.07% to about 0.9%, about 0.08% to about 0.9%, about 0.09% to about 0.9%, about 0.1% to about 0.9%, about 0.2% to about 0.9%, about 0.3% to about 0.9%, about 0.4% to about 0.9%, about 0.5% to about 0.9%, about 0.6% to about 0.9%, about 0.7% to about 0.9%, about 0.8% to about 0.9%, about 0.0001% to about 0.5%, about 0.0002% to about 0.5%, about 0.0003% to about 0.5%, about 0.0004% to about 0.5%, about 0.0005% to about 0.5%, about 0.0006% to about 0.5%, about 0.0007% to about 0.5%, about 0.0008% to about 0.5%, about 0.0009% to about 0.5%, about 0.001% to about 0.5%, about 0.002% to about 0.5%, about 0.003% to about 0.5%, about 0.004% to about 0.5%, about 0.005% to about 0.5%, about 0.006% to about 0.5%, about 0.007% to about 0.5%, about 0.008% to about 0.5%, about 0.009% to about 0.5%, about 0.01% to about 0.5%, about 0.02% to about 0.5%, about 0.03% to about 0.5%, about 0.04% to about 0.5%, about 0.05% to about 0.5%, about 0.06% to about 0.5%, about 0.07% to about 0.5%, about 0.08% to about 0.5%, about 0.09% to about 0.5%, about 0.1% to about 0.5%, about 0.2% to about 0.5%, about 0.3% to about 0.5%, about 0.4% to about 0.5%, about 0.0001% to about 0.3%, about 0.0002% to about 0.3%, about 0.0003% to about 0.3%, about 0.0004% to about 0.3%, about 0.0005% to about 0.3%, about 0.0006% to about 0.3%, about 0.0007% to about 0.3%, about 0.0008% to about 0.3%, about 0.0009% to about 0.3%, about 0.001% to about 0.3%, about 0.002% to about 0.3%, about 0.003% to about 0.3%, about 0.004% to about 0.3%, about 0.005% to about 0.3%, about 0.006% to about 0.3%, about 0.007% to about 0.3%, about 0.008% to about 0.3%, about 0.009% to about 0.3%, about 0.01% to about 0.3%, about 0.02% to about 0.3%, about 0.03% to about 0.3%, about 0.04% to about 0.3%, about 0.05% to about 0.3%, about 0.06% to about 0.3%, about 0.07% to about 0.3%, about 0.08% to about 0.3%, about 0.09% to about 0.3%, about 0.1% to about 0.3%, or about 0.2% to about 0.3% by weight of the iodophor formulation. In some embodiments, the micronutrient may be present in the iodophor formulation in an amount from about 0.001% to about 0.2% by weight of the iodophor formulation.

In some embodiments, the micronutrient may include manganese. The manganese may be present in an amount from about 0.001% to about 1% by weight of the iodophor formulation. For example, the manganese may be present in the iodophor formulation in an amount from about 0.001% to about 1%, about 0.001% to about 0.9%, about 0.001% to about 0.8%, about 0.001% to about 0.7%, about 0.001% to about 0.6%, about 0.001% to about 0.5%, about 0.001% to about 0.4%, about 0.001% to about 0.3%, about 0.001% to about 0.2%, about 0.001% to about 0.1%, about 0.01% to about 1%, about 0.01% to about 0.9%, about 0.01% to about 0.8%, about 0.01% to about 0.7%, about 0.01% to about 0.6%, about 0.01% to about 0.5%, about 0.01% to about 0.4%, about 0.01% to about 0.3%, about 0.01% to about 0.2%, about 0.01% to about 0.1% by weight of the iodophor formulation. In some embodiments, the manganese may be present in the iodophor formulation in an amount from about 0.01 to about 0.1% by weight of the iodophor formulation. For example, the manganese may be present in the iodophor formulation in an amount from about 0.01% to about 0.1%, about 0.02% to about 0.1%, about 0.03% to about 0.1%, about 0.04% to about 0.1%, about 0.05% to about 0.1%, about 0.06% to about 0.1%, about 0.07% to about 0.1%, about 0.08% to about 0.1%, about 0.09% to about 0.1%, about 0.01% to about 0.09%, about 0.02% to about 0.09%, about 0.03% to about 0.09%, about 0.04% to about 0.09%, about 0.05% to about 0.09%, about 0.06% to about 0.09%, about 0.07% to about 0.09%, about 0.08% to about 0.09%, about 0.01% to about 0.08%, about 0.02% to about 0.08%, about 0.03% to about 0.08%, about 0.04% to about 0.08%, about 0.05% to about 0.08%, about 0.06% to about 0.08%, about 0.07% to about 0.08%, about 0.01% to about 0.07%, about 0.02% to about 0.07%, about 0.03% to about 0.07%, about 0.04% to about 0.07%, about 0.05% to about 0.07%, about 0.06% to about 0.07%, about 0.01% to about 0.06%, about 0.02% to about 0.06%, about 0.03% to about 0.06%, about 0.04% to about 0.06%, about 0.05% to about 0.06%, about 0.01% to about 0.05%, about 0.02% to about 0.05%, about 0.03% to about 0.05%, about 0.04% to about 0.05%, about 0.01% to about 0.04%, about 0.02% to about 0.04%, about 0.03% to about 0.04%, about 0.01% to about 0.03%, about 0.02% to about 0.03%, or about 0.01% to about 0.02% by weight of the iodophor formulation.

In some embodiments, the micronutrient may include iron. The iron may be present in the iodophor formulation in an amount from about 0.001% to about 1% by weight of the iodophor formulation. For example, the iron may be present in the iodophor formulation in an amount from about 0.001% to about 1%, about 0.001% to about 0.9%, about 0.001% to about 0.8%, about 0.001% to about 0.7%, about 0.001% to about 0.6%, about 0.001% to about 0.5%, about 0.001% to about 0.4%, about 0.001% to about 0.3%, about 0.001% to about 0.2%, about 0.001% to about 0.1%, about 0.005% to about 1%, about 0.005% to about 0.9%, about 0.005% to about 0.8%, about 0.005% to about 0.7%, about 0.005% to about 0.6%, about 0.005% to about 0.5%, about 0.005% to about 0.4%, about 0.005% to about 0.3%, about 0.005% to about 0.2%, about 0.005% to about 0.1%, about 0.01% to about 1%, about 0.01% to about 0.9%, about 0.01% to about 0.8%, about 0.01% to about 0.7%, about 0.01% to about 0.6%, about 0.01% to about 0.5%, about 0.01% to about 0.4%, about 0.01% to about 0.3%, about 0.01% to about 0.2%, about 0.01% to about 0.1% by weight of the iodophor formulation. In some embodiments, the iron may be present in the iodophor formulation in an amount from about 0.01% to about 0.2% by weight of the iodophor formulation. For example, the iron may be present in the iodophor formulation in an amount from about 0.01% to about 0.2%, about 0.02% to about 0.2%, about 0.03% to about 0.2%, about 0.04% to about 0.2%, about 0.05% to about 0.2%, about 0.06% to about 0.2%, about 0.07% to about 0.2%, about 0.08% to about 0.2%, about 0.09% to about 0.2%, about 0.1% to about 0.2%, about 0.01% to about 0.19%, about 0.02% to about 0.19%, about 0.03% to about 0.19%, about 0.04% to about 0.19%, about 0.05% to about 0.19%, about 0.06% to about 0.19%, about 0.07% to about 0.19%, about 0.08% to about 0.19%, about 0.09% to about 0.19%, about 0.1% to about 0.19%, about 0.12% to about 0.19%, about 0.1% to about 0.19%, about 0.01% to about 0.18%, about 0.02% to about 0.18%, about 0.03% to about 0.18%, about 0.04% to about 0.18%, about 0.05% to about 0.18%, about 0.06% to about 0.18%, about 0.07% to about 0.18%, about 0.08% to about 0.18%, about 0.09% to about 0.18%, about 0.1% to about 0.18%, about 0.01% to about 0.17%, about 0.02% to about 0.17%, about 0.03% to about 0.17%, about 0.04% to about 0.17%, about 0.05% to about 0.17%, about 0.06% to about 0.17%, about 0.07% to about 0.17%, about 0.08% to about 0.17%, about 0.09% to about 0.17%, about 0.1% to about 0.17%, about 0.01% to about 0.16%, about 0.02% to about 0.16%, about 0.03% to about 0.16%, about 0.04% to about 0.16%, about 0.05% to about 0.16%, about 0.06% to about 0.16%, about 0.07% to about 0.16%, about 0.08% to about 0.16%, about 0.09% to about 0.16%, about 0.1% to about 0.16%, about 0.01% to about 0.15%, about 0.02% to about 0.15%, about 0.03% to about 0.15%, about 0.04% to about 0.15%, about 0.05% to about 0.15%, about 0.06% to about 0.15%, about 0.07% to about 0.15%, about 0.08% to about 0.15%, about 0.09% to about 0.15%, about 0.1% to about 0.15%, about 0.01% to about 0.14%, about 0.02% to about 0.14%, about 0.03% to about 0.14%, about 0.04% to about 0.14%, about 0.05% to about 0.14%, about 0.06% to about 0.14%, about 0.07% to about 0.14%, about 0.08% to about 0.14%, about 0.09% to about 0.14%, about 0.1% to about 0.14%, about 0.01% to about 0.13%, about 0.02% to about 0.13%, about 0.03% to about 0.13%, about 0.04% to about 0.13%, about 0.05% to about 0.13%, about 0.06% to about 0.13%, about 0.07% to about 0.13%, about 0.08% to about 0.13%, about 0.09% to about 0.13%, about 0.1% to about 0.13%, about 0.01% to about 0.12%, about 0.02% to about 0.12%, about 0.03% to about 0.12%, about 0.04% to about 0.12%, about 0.05% to about 0.12%, about 0.06% to about 0.12%, about 0.07% to about 0.12%, about 0.08% to about 0.12%, about 0.09% to about 0.12%, about 0.1% to about 0.12%, about 0.01% to about 0.11%, about 0.02% to about 0.11%, about 0.03% to about 0.11%, about 0.04% to about 0.11%, about 0.05% to about 0.11%, about 0.06% to about 0.11%, about 0.07% to about 0.11%, about 0.08% to about 0.11%, about 0.09% to about 0.11%, about 0.1% to about 0.11%, 0.01% to about 0.1%, about 0.02% to about 0.1%, about 0.03% to about 0.1%, about 0.04% to about 0.1%, about 0.05% to about 0.1%, about 0.06% to about 0.1%, about 0.07% to about 0.1%, about 0.08% to about 0.1%, about 0.09% to about 0.1%, about 0.01% to about 0.09%, about 0.02% to about 0.09%, about 0.03% to about 0.09%, about 0.04% to about 0.09%, about 0.05% to about 0.09%, about 0.06% to about 0.09%, about 0.07% to about 0.09%, about 0.08% to about 0.09%, about 0.01% to about 0.08%, about 0.02% to about 0.08%, about 0.03% to about 0.08%, about 0.04% to about 0.08%, about 0.05% to about 0.08%, about 0.06% to about 0.08%, about 0.07% to about 0.08%, about 0.01% to about 0.07%, about 0.02% to about 0.07%, about 0.03% to about 0.07%, about 0.04% to about 0.07%, about 0.05% to about 0.07%, about 0.06% to about 0.07%, about 0.01% to about 0.06%, about 0.02% to about 0.06%, about 0.03% to about 0.06%, about 0.04% to about 0.06%, about 0.05% to about 0.06%, about 0.01% to about 0.05%, about 0.02% to about 0.05%, about 0.03% to about 0.05%, about 0.04% to about 0.05%, about 0.01% to about 0.04%, about 0.02% to about 0.04%, about 0.03% to about 0.04%, about 0.01% to about 0.03%, about 0.02% to about 0.03%, or about 0.01% to about 0.02% by weight of the iodophor formulation. In some embodiments, the iron may be present in the iodophor formulation in an amount from about 0.05% to about 0.2% by weight of the iodophor formulation. For example, the iron may be present in the iodophor formulation in an amount from about 0.05% to about 0.2%, about 0.06% to about 0.2%, about 0.07% to about 0.2%, about 0.08% to about 0.2%, about 0.09% to about 0.2%, about 0.1% to about 0.2%, about 0.11% to about 0.2%, about 0.12% to about 0.2%, about 0.13% to about 0.2%, about 0.14% to about 0.2%, about 0.15% to about 0.2%, about 0.16% to about 0.2%, about 0.17% to about 0.2%, about 0.18% to about 0.2%, about 0.19% to about 0.2%, about 0.05% to about 0.1%, about 0.06% to about 0.1%, about 0.07% to about 0.1%, about 0.08% to about 0.1%, or about 0.09% to about 0.1% by weight of the iodophor formulation.

In some embodiments, the micronutrient in the iodophor formulation may include zinc. The zinc may be present in the iodophor formulation in an amount from about 0.001% to about 1% by weight of the iodophor formulation. For example, the zinc may be present in the iodophor formulation in an amount from about 0.001% to about 1%, about 0.001% to about 0.9%, about 0.001% to about 0.8%, about 0.001% to about 0.7%, about 0.001% to about 0.6%, about 0.001% to about 0.5%, about 0.001% to about 0.4%, about 0.001% to about 0.3%, about 0.001% to about 0.2%, about 0.001% to about 0.1%, about 0.005% to about 1%, about 0.005% to about 0.9%, about 0.005% to about 0.8%, about 0.005% to about 0.7%, about 0.005% to about 0.6%, about 0.005% to about 0.5%, about 0.005% to about 0.4%, about 0.005% to about 0.3%, about 0.005% to about 0.2%, about 0.005% to about 0.1%, about 0.01% to about 1%, about 0.01% to about 0.9%, about 0.01% to about 0.8%, about 0.01% to about 0.7%, about 0.01% to about 0.6%, about 0.01% to about 0.5%, about 0.01% to about 0.4%, about 0.01% to about 0.3%, about 0.01% to about 0.2%, about 0.01% to about 0.1% by weight of the iodophor formulation. In some embodiments, the zinc may be present in the iodophor formulation in an amount from about 0.01% to about 0.1% by weight of the iodophor formulation. For example, the zinc may be present in the iodophor formulation in an amount from about 0.01% to about 0.1%, about 0.02% to about 0.1%, about 0.03% to about 0.1%, about 0.04% to about 0.1%, about 0.05% to about 0.1%, about 0.06% to about 0.1%, about 0.07% to about 0.1%, about 0.08% to about 0.1%, about 0.09% to about 0.1%, about 0.01% to about 0.09%, about 0.02% to about 0.09%, about 0.03% to about 0.09%, about 0.04% to about 0.09%, about 0.05% to about 0.09%, about 0.06% to about 0.09%, about 0.07% to about 0.09%, about 0.08% to about 0.09%, about 0.01% to about 0.08%, about 0.02% to about 0.08%, about 0.03% to about 0.08%, about 0.04% to about 0.08%, about 0.05% to about 0.08%, about 0.06% to about 0.08%, about 0.07% to about 0.08%, about 0.01% to about 0.07%, about 0.02% to about 0.07%, about 0.03% to about 0.07%, about 0.04% to about 0.07%, about 0.05% to about 0.07%, about 0.06% to about 0.07%, about 0.01% to about 0.06%, about 0.02% to about 0.06%, about 0.03% to about 0.06%, about 0.04% to about 0.06%, about 0.05% to about 0.06%, about 0.01% to about 0.05%, about 0.02% to about 0.05%, about 0.03% to about 0.05%, about 0.04% to about 0.05%, about 0.01% to about 0.04%, about 0.02% to about 0.04%, about 0.03% to about 0.04%, about 0.01% to about 0.03%, about 0.02% to about 0.03%, or about 0.01% to about 0.02% by weight of the iodophor formulation.

In some embodiments, the micronutrient in the iodophor formulation may include copper. The copper may be present in the iodophor formulation in an amount from about 0.001% to about 1% by weight of the iodophor formulation. For example, the copper may be present in the iodophor formulation in an amount from about 0.001% to about 1%, about 0.001% to about 0.9%, about 0.001% to about 0.8%, about 0.001% to about 0.7%, about 0.001% to about 0.6%, about 0.001% to about 0.5%, about 0.001% to about 0.4%, about 0.001% to about 0.3%, about 0.001% to about 0.2%, about 0.001% to about 0.1%, about 0.005% to about 1%, about 0.005% to about 0.9%, about 0.005% to about 0.8%, about 0.005% to about 0.7%, about 0.005% to about 0.6%, about 0.005% to about 0.5%, about 0.005% to about 0.4%, about 0.005% to about 0.3%, about 0.005% to about 0.2%, about 0.005% to about 0.1%, about 0.01% to about 1%, about 0.01% to about 0.9%, about 0.01% to about 0.8%, about 0.01% to about 0.7%, about 0.01% to about 0.6%, about 0.01% to about 0.5%, about 0.01% to about 0.4%, about 0.01% to about 0.3%, about 0.01% to about 0.2%, about 0.01% to about 0.1% by weight of the iodophor formulation. In some embodiments, the copper may be present in the iodophor formulation in an amount from about 0.01% to about 0.1% by weight of the iodophor formulation. For example, the copper may be present in the iodophor formulation in an amount from about 0.01% to about 0.1%, about 0.02% to about 0.1%, about 0.03% to about 0.1%, about 0.04% to about 0.1%, about 0.05% to about 0.1%, about 0.06% to about 0.1%, about 0.07% to about 0.1%, about 0.08% to about 0.1%, about 0.09% to about 0.1%, about 0.01% to about 0.09%, about 0.02% to about 0.09%, about 0.03% to about 0.09%, about 0.04% to about 0.09%, about 0.05% to about 0.09%, about 0.06% to about 0.09%, about 0.07% to about 0.09%, about 0.08% to about 0.09%, about 0.01% to about 0.08%, about 0.02% to about 0.08%, about 0.03% to about 0.08%, about 0.04% to about 0.08%, about 0.05% to about 0.08%, about 0.06% to about 0.08%, about 0.07% to about 0.08%, about 0.01% to about 0.07%, about 0.02% to about 0.07%, about 0.03% to about 0.07%, about 0.04% to about 0.07%, about 0.05% to about 0.07%, about 0.06% to about 0.07%, about 0.01% to about 0.06%, about 0.02% to about 0.06%, about 0.03% to about 0.06%, about 0.04% to about 0.06%, about 0.05% to about 0.06%, about 0.01% to about 0.05%, about 0.02% to about 0.05%, about 0.03% to about 0.05%, about 0.04% to about 0.05%, about 0.01% to about 0.04%, about 0.02% to about 0.04%, about 0.03% to about 0.04%, about 0.01% to about 0.03%, about 0.02% to about 0.03%, or about 0.01% to about 0.02% by weight of the iodophor formulation.

In some embodiments, the micronutrient in the iodophor formulation may include boron. The boron may be present in the iodophor formulation in an amount from about 0.001% to about 1% by weight of the iodophor formulation. For example, the boron may be present in the iodophor formulation in an amount from about 0.001% to about 1%, 0.001% to about 0.9%, 0.001% to about 0.8%, 0.001% to about 0.7%, 0.001% to about 0.6%, 0.001% to about 0.5%, 0.001% to about 0.4%, 0.001% to about 0.3%, 0.001% to about 0.2%, 0.001% to about 0.1%, about 0.005% to about 0.1%, about 0.01% to about 0.1%, about 0.015% to about 0.1%, about 0.02% to about 0.1%, about 0.025% to about 0.1%, about 0.03% to about 0.1%, about 0.035% to about 0.1%, about 0.04% to about 0.1%, about 0.045% to about 0.1%, about 0.05% to about 0.1%, about 0.055% to about 0.1%, about 0.06% to about 0.1%, about 0.065% to about 0.1%, about 0.07% to about 0.1%, about 0.075% to about 0.1%, about 0.08% to about 0.1%, about 0.085% to about 0.1%, about 0.09% to about 0.1%, about 0.095% to about 0.1%, about 0.001% to about 0.09%, about 0.005% to about 0.09%, about 0.01% to about 0.09%, about 0.015% to about 0.09%, about 0.02% to about 0.09%, about 0.025% to about 0.09%, about 0.03% to about 0.09%, about 0.035% to about 0.09%, about 0.04% to about 0.09%, about 0.045% to about 0.09%, about 0.05% to about 0.09%, about 0.055% to about 0.09%, about 0.06% to about 0.09%, about 0.065% to about 0.09%, about 0.07% to about 0.09%, about 0.075% to about 0.09%, about 0.08% to about 0.09%, about 0.085% to about 0.09%, about 0.001% to about 0.08%, about 0.005% to about 0.08%, about 0.01% to about 0.08%, about 0.015% to about 0.08%, about 0.02% to about 0.08%, about 0.025% to about 0.08%, about 0.03% to about 0.08%, about 0.035% to about 0.08%, about 0.04% to about 0.08%, about 0.045% to about 0.08%, about 0.05% to about 0.08%, about 0.055% to about 0.08%, about 0.06% to about 0.08%, about 0.065% to about 0.08%, about 0.07% to about 0.08%, about 0.075% to about 0.08%, about 0.001% to about 0.07%, about 0.005% to about 0.07%, about 0.01% to about 0.07%, about 0.015% to about 0.07%, about 0.02% to about 0.07%, about 0.025% to about 0.07%, about 0.03% to about 0.07%, about 0.035% to about 0.07%, about 0.04% to about 0.07%, about 0.045% to about 0.07%, about 0.05% to about 0.07%, about 0.055% to about 0.07%, about 0.06% to about 0.07%, about 0.065% to about 0.07%, about 0.001% to about 0.06%, about 0.005% to about 0.06%, about 0.01% to about 0.06%, about 0.015% to about 0.06%, about 0.02% to about 0.06%, about 0.025% to about 0.06%, about 0.03% to about 0.06%, about 0.035% to about 0.06%, about 0.04% to about 0.06%, about 0.045% to about 0.06%, about 0.05% to about 0.06%, about 0.055% to about 0.06%, about 0.001% to about 0.05%, about 0.005% to about 0.05%, about 0.01% to about 0.05%, about 0.015% to about 0.05%, about 0.02% to about 0.05%, about 0.025% to about 0.05%, about 0.03% to about 0.05%, about 0.035% to about 0.05%, about 0.04% to about 0.05%, about 0.045% to about 0.05%, about 0.001% to about 0.04%, about 0.005% to about 0.04%, about 0.01% to about 0.04%, about 0.015% to about 0.04%, about 0.02% to about 0.04%, about 0.025% to about 0.04%, about 0.03% to about 0.04%, about 0.035% to about 0.04%, about 0.001% to about 0.03%, about 0.005% to about 0.03%, about 0.01% to about 0.03%, about 0.015% to about 0.03%, about 0.02% to about 0.03%, about 0.025% to about 0.03%, about 0.001% to about 0.02%, about 0.005% to about 0.02%, about 0.01% to about 0.02%, about 0.015% to about 0.02%, about 0.001% to about 0.02%, about 0.001% to about 0.01%, or about 0.005% to about 0.01%. In some embodiments, the boron may be present in the iodophor formulation in an amount from about 0.005% to about 0.1% by weight of the iodophor formulation. For example, the boron may be present in the iodophor formulation in an amount from about 0.005% to about 0.05%, about 0.006% to about 0.05%, about 0.007% to about 0.05%, about 0.008% to about 0.05%, about 0.009% to about 0.05%, about 0.01% to about 0.05%, about 0.02% to about 0.05%, about 0.03% to about 0.05%, about 0.04% to about 0.05%, about 0.005% to about 0.04%, about 0.006% to about 0.04%, about 0.007% to about 0.04%, about 0.008% to about 0.04%, about 0.009% to about 0.04%, about 0.01% to about 0.04%, about 0.02% to about 0.04%, about 0.03% to about 0.04%, about 0.005% to about 0.03%, about 0.006% to about 0.03%, about 0.007% to about 0.03%, about 0.008% to about 0.03%, about 0.009% to about 0.03%, about 0.01% to about 0.03%, about 0.02% to about 0.03%, about 0.005% to about 0.02%, about 0.006% to about 0.02%, about 0.007% to about 0.02%, about 0.008% to about 0.02%, about 0.009% to about 0.02%, about 0.01% to about 0.02%, about 0.005% to about 0.01%, about 0.006% to about 0.01%, about 0.007% to about 0.01%, about 0.008% to about 0.01%, about 0.009% to about 0.01%, about 0.005% to about 0.009%, about 0.006% to about 0.009%, about 0.007% to about 0.009%, about 0.008% to about 0.009%, about 0.005% to about 0.008%, about 0.006% to about 0.008%, about 0.007% to about 0.008%, about 0.005% to about 0.007%, about 0.006% to about 0.007%, or about 0.005% to about 0.006% by weight of the iodophor formulation.

In some embodiments, the micronutrient in the iodophor formulation may include molybdenum. The molybdenum may be present in the iodophor formulation in an amount from about 0.001% to about 1% by weight of the iodophor formulation. For example, the molybdenum may be present in the iodophor formulation in an amount from about 0.001% to about 1%, 0.001% to about 0.9%, 0.001% to about 0.8%, 0.001% to about 0.7%, 0.001% to about 0.6%, 0.001% to about 0.5%, 0.001% to about 0.4%, 0.001% to about 0.3%, 0.001% to about 0.2%, about 0.001% to about 0.1%, about 0.005% to about 0.1%, about 0.01% to about 0.1%, about 0.015% to about 0.1%, about 0.02% to about 0.1%, about 0.025% to about 0.1%, about 0.03% to about 0.1%, about 0.035% to about 0.1%, about 0.04% to about 0.1%, about 0.045% to about 0.1%, about 0.05% to about 0.1%, about 0.055% to about 0.1%, about 0.06% to about 0.1%, about 0.065% to about 0.1%, about 0.07% to about 0.1%, about 0.075% to about 0.1%, about 0.08% to about 0.1%, about 0.085% to about 0.1%, about 0.09% to about 0.1%, about 0.095% to about 0.1%, about 0.001% to about 0.09%, about 0.005% to about 0.09%, about 0.01% to about 0.09%, about 0.015% to about 0.09%, about 0.02% to about 0.09%, about 0.025% to about 0.09%, about 0.03% to about 0.09%, about 0.035% to about 0.09%, about 0.04% to about 0.09%, about 0.045% to about 0.09%, about 0.05% to about 0.09%, about 0.055% to about 0.09%, about 0.06% to about 0.09%, about 0.065% to about 0.09%, about 0.07% to about 0.09%, about 0.075% to about 0.09%, about 0.08% to about 0.09%, about 0.085% to about 0.09%, about 0.001% to about 0.08%, about 0.005% to about 0.08%, about 0.01% to about 0.08%, about 0.015% to about 0.08%, about 0.02% to about 0.08%, about 0.025% to about 0.08%, about 0.03% to about 0.08%, about 0.035% to about 0.08%, about 0.04% to about 0.08%, about 0.045% to about 0.08%, about 0.05% to about 0.08%, about 0.055% to about 0.08%, about 0.06% to about 0.08%, about 0.065% to about 0.08%, about 0.07% to about 0.08%, about 0.075% to about 0.08%, about 0.001% to about 0.07%, about 0.005% to about 0.07%, about 0.01% to about 0.07%, about 0.015% to about 0.07%, about 0.02% to about 0.07%, about 0.025% to about 0.07%, about 0.03% to about 0.07%, about 0.035% to about 0.07%, about 0.04% to about 0.07%, about 0.045% to about 0.07%, about 0.05% to about 0.07%, about 0.055% to about 0.07%, about 0.06% to about 0.07%, about 0.065% to about 0.07%, about 0.001% to about 0.06%, about 0.005% to about 0.06%, about 0.01% to about 0.06%, about 0.015% to about 0.06%, about 0.02% to about 0.06%, about 0.025% to about 0.06%, about 0.03% to about 0.06%, about 0.035% to about 0.06%, about 0.04% to about 0.06%, about 0.045% to about 0.06%, about 0.05% to about 0.06%, about 0.055% to about 0.06%, about 0.001% to about 0.05%, about 0.005% to about 0.05%, about 0.01% to about 0.05%, about 0.015% to about 0.05%, about 0.02% to about 0.05%, about 0.025% to about 0.05%, about 0.03% to about 0.05%, about 0.035% to about 0.05%, about 0.04% to about 0.05%, about 0.045% to about 0.05%, about 0.001% to about 0.04%, about 0.005% to about 0.04%, about 0.01% to about 0.04%, about 0.015% to about 0.04%, about 0.02% to about 0.04%, about 0.025% to about 0.04%, about 0.03% to about 0.04%, about 0.035% to about 0.04%, about 0.001% to about 0.03%, about 0.005% to about 0.03%, about 0.01% to about 0.03%, about 0.015% to about 0.03%, about 0.02% to about 0.03%, about 0.025% to about 0.03%, about 0.001% to about 0.02%, about 0.005% to about 0.02%, about 0.01% to about 0.02%, about 0.015% to about 0.02%, about 0.001% to about 0.02%, about 0.001% to about 0.01%, or about 0.005% to about 0.01% by weight of the iodophor formulation. In some embodiments, the molybdenum may be present in the iodophor formulation in an amount from about 0.001% to about 0.01% by weight of the iodophor formulation. For example, the molybdenum may be present in the iodophor formulation in an amount from 0.001% to about 0.01%, about 0.002% to about 0.01%, about 0.003% to about 0.01%, about 0.004% to about 0.01%, about 0.005% to about 0.01%, about 0.006% to about 0.01%, about 0.007% to about 0.01%, about 0.008% to about 0.01%, about 0.009% to about 0.01%, about 0.001% to about 0.009%, about 0.002% to about 0.009%, about 0.003% to about 0.009%, about 0.004% to about 0.009%, about 0.005% to about 0.009%, about 0.006% to about 0.009%, about 0.007% to about 0.009%, about 0.008% to about 0.009%, about 0.001% to about 0.008%, about 0.002% to about 0.008%, about 0.003% to about 0.008%, about 0.004% to about 0.008%, about 0.005% to about 0.008%, about 0.006% to about 0.008%, about 0.007% to about 0.008%, about 0.001% to about 0.007%, about 0.002% to about 0.007%, about 0.003% to about 0.007%, about 0.004% to about 0.007%, about 0.005% to about 0.007%, about 0.006% to about 0.007%, about 0.001% to about 0.006%, about 0.002% to about 0.006%, about 0.003% to about 0.006%, about 0.004% to about 0.006%, about 0.005% to about 0.006%, about 0.001% to about 0.005%, about 0.002% to about 0.005%, about 0.003% to about 0.005%, about 0.004% to about 0.005%, about 0.001% to about 0.004%, about 0.002% to about 0.004%, about 0.003% to about 0.004%, about 0.001% to about 0.003%, about 0.002% to about 0.003%, or about 0.001% to about 0.002% by weight.

The additive may include a humectant, wetting agent, adjuvant, an amphoteric surfactant, or a combination thereof. Examples of humectants include but are not limited to glycerin, hyaluronic acid, propylene glycol, urea, or sorbitol. In some embodiments the additive may be a humectant. In some embodiments the humectant may be glycerin, propylene glycol, or both. Examples of amphoteric surfactants include but are not limited to cocamidopropyl betaine, lauryl betaine, or disodium cocoamphodiacetate. In some embodiments, the amphoteric surfactant may be cocamidopropyl betaine. Examples of wetting agents include but are not limited to yucca extract, soy lecithin, sodium lauryl sulfate, organosilicone surfactants, or any combination thereof. Examples of adjuvants include but are not limited to vegetable oils, methylated seed oils, organosilicones, monosilicic acid, or any combination thereof.

The additive may be present in an amount from about 0% to about 10% by weight of the iodophor formulation. For example, the additive may be present in the iodophor formulation in an amount from about 0% to about 10%, about 0.5% to about 10%, about 1% to about 10%, about 1.5% to about 10%, about 2% to about 10%, about 2.5% to about 10%, about 3% to about 10%, about 3.5% to about 10%, about 4% to about 10%, about 4.5% to about 10%, about 5% to about 10%, about 5.5% to about 10%, about 6% to about 10%, about 6.5% to about 10%, about 7% to about 10%, about 7.5% to about 10%, about 2% to about 8%, about 8.5% to about 10%, about 9% to about 10%, or about 9.5% to about 10% by weight of the iodophor formulation. In some embodiments, the additive may be present in an amount from about 0% to about 1%, about 0% to about 2%, about 0% to about 3%, about 0% to about 4%, about 0% to about 5%, about 0% to about 6%, about 0% to about 7%, about 0% to about 8%, about 0% to about 9%, or about 0% to about 10% by weight of the iodophor formulation. In some embodiments, the additive may be present in an amount from about 1% to about 9%, about 2% to about 8%, about 3% to about 7%, or about 4% to about 6% by weight of the iodophor formulation.

The propylene glycol may be present in the iodophor formulation in an amount from about 0% to about 5% by weight of the iodophor formulation. For example, the propylene glycol may be present in the iodophor formulation in an amount from about 0% to about 5%, about 1% to about 5%, about 2% to about 5%, about 3% to about 5%, about 4% to about 5%, about 0% to about 4%, about 1% to about 4%, about 2% to about 4%, about 3% to about 4%, about 0% to about 3%, about 1% to about 3%, about 2% to about 3%, about 0% to about 2%, or about 1% to about 2% by weight of the iodophor formulation. In some embodiments, the propylene glycol may be present in the iodophor formulation in an amount of about 5% by weight of the iodophor formulation.

The glycerin may be present in the iodophor formulation in an amount from about 0% to about 5% by weight of the iodophor formulation. For example, the glycerin may be present in the iodophor formulation in an amount from about 0% to about 5%, about 1% to about 5%, about 2% to about 5%, about 3% to about 5%, about 4% to about 5%, about 0% to about 4%, about 1% to about 4%, about 2% to about 4%, about 3% to about 4%, about 0% to about 3%, about 1% to about 3%, about 2% to about 3%, about 0% to about 2%, or about 1% to about 2% by weight of the iodophor formulation. In some embodiments, glycerin may be present in the iodophor formulation in an amount of about 5% by weight of the iodophor formulation.

The cocamidopropyl betaine may be present in the iodophor formulation in an amount from about 0% to about 5% by weight of the iodophor formulation. For example, the cocamidopropyl betaine may be present in the iodophor formulation in an amount from about 0% to about 5%, about 1% to about 5%, about 2% to about 5%, about 3% to about 5%, about 4% to about 5%, about 0% to about 4%, about 1% to about 4%, about 2% to about 4%, about 3% to about 4%, about 0% to about 3%, about 1% to about 3%, about 2% to about 3%, about 0% to about 2%, or about 1% to about 2% by weight of the iodophor formulation. In some embodiments, the cocamidopropyl betaine may be present in the iodophor formulation in an amount from about 15 to about 2% by weight of the iodophor formulation. The cocamidopropyl betaine may be present in the iodophor formulation in an amount from about 1% to about 2%, about 1.1% to about 2%, about 1.2% to about 2%, about 1.2% to about 2%, about 1.3% to about 2%, about 1.4% to about 2%, about 1.5% to about 2%, about 1.6% to about 2%, about 1.7% to about 2%, about 1.8% to about 2%, or about 1.9% to about 2% by weight of the iodophor formulation.

The agriculturally acceptable liquid carrier or diluent may be water. In some embodiments, the water may be demineralized water. The amount of liquid carrier in the iodophor formulation may be from about 40% to about 80% by weight. For example, the amount may be about 40% to about 80%, about 41% to about 80%, about 42% to about 80%, about 43% to about 80%, about 44% to about 80%, about 45% to about 80%, about 46% to about 80%, about 47% to about 80%, about 48% to about 80%, about 49% to about 80%, about 50% to about 80%, about 51% to about 80%, about 52% to about 80%, about 53% to about 80%, about 54% to about 80%, about 55% to about 80%, about 56% to about 80%, about 57% to about 80%, about 58% to about 80%, about 59% to about 80%, about 60% to about 80%, about 61% to about 80%, about 62% to about 80%, about 63% to about 80%, about 64% to about 80%, about 65% to about 80%, about 66% to about 80%, about 67% to about 80%, about 68% to about 80%, about 69% to about 80%, about 70% to about 80%, about 71% to about 80%, about 72% to about 80%, about 73% to about 80%, about 74% to about 80%, about 75% to about 80%, about 76% to about 80%, about 77% to about 80%, about 78% to about 80%, or about 79% to about 80% by weight. In some embodiments, the amount of liquid carrier in the iodophor formulation may be from about 40% to about 41%, about 40% to about 42%, about 40% to about 43%, about 40% to about 44%, about 40% to about 45%, about 40% to about 46%, about 40% to about 47%, about 40% to about 48%, about 40% to about 49%, about 40% to about 50%, about 40% to about 51%, about 40% to about 52%, about 40% to about 53%, about 40% to about 54%, about 40% to about 55%, about 40% to about 56%, about 40% to about 57%, about 40% to about 58%, about 40% to about 59%, about 40% to about 60%, about 40% to about 61%, about 40% to about 62%, about 40% to about 63%, about 40% to about 64%, about 40% to about 65%, about 40% to about 66%, about 40% to about 67%, about 40% to about 68%, about 40% to about 69%, about 40% to about 70%, about 40% to about 71%, about 40% to about 72%, about 40% to about 73%, about 40% to about 74%, about 40% to about 75%, about 40% to about 76%, about 40% to about 77%, about 40% to about 78%, about 40% to about 79%, or about 40% to about 80% by weight. In some embodiments, the amount of liquid carrier in the iodophor formulation may be from about 35% to about 75%, about 40% to about 70%, about 45% to about 65%, or about 50% to about 60% by weight.

The crop may be sprayed with an aqueous solution comprising from 0.01% (v/v) to 5% (v/v) of the disclosed iodophor formulation. For example, the aqueous solution may have from about 0.01% (v/v) to about 5% (v/v), about 0.02% (v/v) to about 5% (v/v), about 0.03% (v/v) to about 5% (v/v), about 0.04% (v/v) to about 5% (v/v), about 0.05% (v/v) to about 5% (v/v), about 0.06% (v/v) to about 5% (v/v), about 0.07% (v/v) to about 5% (v/v), about 0.08% (v/v) to about 5% (v/v), about 0.09% (v/v) to about 5% (v/v), 0.1% (v/v) to 5% (v/v), about 0.2% (v/v) to about 5% (v/v), about 0.3% (v/v) to about 5% (v/v), about 0.4% (v/v) to about 5% (v/v), about 0.5% (v/v) to about 5% (v/v), about 0.6% (v/v) to about 5% (v/v), about 0.7% (v/v) to about 5% (v/v), about 0.8% (v/v) to about 5% (v/v), about 0.9% (v/v) to about 5% (v/v), 1% (v/v) to 5% (v/v), about 2% (v/v) to about 5% (v/v), about 3% (v/v) to about 5% (v/v), or about 4% (v/v) to about 5% (v/v). In some embodiments, the aqueous solution may have from about 0.01% (v/v) to about 5% (v/v), about 0.05% (v/v) to about 4.5% (v/v), about 0.1% (v/v) to about 4% (v/v), about 0.2% (v/v) to about 3.5% (v/v), about 0.3% (v/v) to about 3% (v/v), about 0.4% (v/v) to about 2.5% (v/v), about 0.5% (v/v) to about 2% (v/v), about 0.6% (v/v) to about 1.5% (v/v), or about 0.7% (v/v) to about 1.0% (v/v) of the disclosed iodophor formulation. of the disclosed iodophor formulation. In some embodiments, the aqueous solution may have from about 0.00625% (v/v) to about 3% (v/v) of the disclosed iodophor formulation.

### Advantages of the Iodophor Formulation

The iodophor formulation may enhance agricultural productivity by combining stabilized iodine and essential nutrients to improve plant health and crop yields. In particular, the iodophor formulation may: 1) enhance root system development; 2) promote larger leaf growth; 3) stimulate better crop formation and quality; 4) complement existing fertilization strategies; 5) provide sustained nutrient availability; 6) improve resilience against abiotic stress; 7) support microbial soil health; or 8) offer compatibility with sustainable practice. The micronutrients and chelated micronutrients may provide essential support for plant growth, physiological processes, and stress resilience.

In some embodiments, the iodophor formulation may enhance root system development by increasing water and nutrient absorption capacity of the root system. The formulation may promote firmer, larger root systems, enabling plants to thrive in diverse soil conditions and withstand drought or nutrient stress.

In some embodiments, the iodophor formulation may promote larger leaf growth by improving photosynthetic efficiency and energy production. The increased leaf size may lead to enhanced light capture and photosynthetic activity, resulting in higher energy availability for growth and reproduction.

In some embodiments, the iodophor formulation may stimulate better crop formation and quality by enabling higher yields and better-quality produce. Treated crops may exhibit larger size, improved firmness, better nutritional content, or any combination thereof. The iodophor formulation may boost overall yield per hectare while enhancing the consistency of crop output. By increasing nutrient uptake efficiency and minimizing leaching, the iodophor formulation may reduce the need for excess fertilizer application, lowering costs for farmers.

In some embodiments, the iodophor formulation may complement existing fertilization strategies by providing bioavailable iodine and targeted macronutrients and micronutrients. The formulation may be used alongside existing fertilizer programs, enhancing their effectiveness without replacing them. The inclusion of biodegradable chelating agents and surfactants may ensure minimal environmental impact, aligning with sustainable and eco-friendly farming practices. By increasing nutrient uptake efficiency and minimizing leaching, the iodophor formulation may reduce the need for excess fertilizer application, lowering costs for farmers.

In some embodiments, the iodophor formulation may provide sustained nutrient availability by utilizing chelating agents to ensure a slow, steady release of nutrients, optimizing absorption over time while minimizing leaching or environmental contamination.

In some embodiments, the iodophor formulation may improve resilience against abiotic stress by enhancing plant tolerance to drought, salinity, and extreme temperature variations through systemic nutrient delivery and balanced plant physiology. Treated plants may show enhanced tolerance to abiotic stresses such as drought, salinity, and extreme temperatures, contributing to more stable yields under adverse conditions.

In some embodiments, the iodophor formulation may support microbial soil health by promoting beneficial microbial activity in the rhizosphere, improving soil structure and nutrient cycling. In some embodiments, the iodophor formulation may offer compatibility with sustainable practices by incorporating environmentally friendly and biodegradable components to align with modern sustainable and organic farming requirements.

Crops treated with the iodophor formulation may demonstrate improved post-harvest quality, including longer shelf life and reduced spoilage, enhancing marketability and profitability. The iodophor formulation may be adapted to specific crops or regional conditions, providing flexibility for diverse agricultural systems.

### Method of Making

The present disclosure is also directed to a method of preparing an iodophor formulation. The method includes dissolving one or more nutrients (i.e., micronutrients and/or macronutrients) in water to prepare a nutrient solution; dissolving iodide salt in water to form a iodide salt solution; adding elemental iodine to the iodide salt solution in the water to prepare an iodine mixture; adding a nonionic surfactant to the nutrient solution forming a nonionic surfactant nutrient solution; combining the nonionic surfactant nutrient solution and the iodine mixture to form the iodophor formulation; and optionally adding an additive.

The method includes preparing a nutrient solution by dissolving one or more nutrients in water. The nutrients may be added gradually into water. The water may be stirred continuously. The nutrients may be added gradually to prevent clumping. The water temperature may be from about 20° C. to about 50° C. For example, the water temperature may be from about 21° C. to about 50° C., about 22° C. to about 50° C., about 23° C. to about 50° C., about 24° C. to about 50° C., about 25° C. to about 50° C., about 26° C. to about 50° C., about 27° C. to about 50° C., about 28° C. to about 50° C., about 29° C. to about 50° C., about 31° C. to about 50° C., about 32° C. to about 50° C., about 33° C. to about 50° C., about 34° C. to about 50° C., about 35° C. to about 50° C., about 36° C. to about 50° C., about 37° C. to about 50° C., about 38° C. to about 50° C., about 39° C. to about 50° C., about 40° C. to about 50° C., about 41° C. to about 50° C., about 42° C. to about 50° C., about 43° C. to about 50° C., about 44° C. to about 50° C., about 45° C. to about 50° C., about 46° C. to about 50° C., about 47° C. to about 50° C., about 48° C. to about 50° C., or about 49° C. to about 50° C. In some embodiments, the water temperature may be from 40° C. to 45° C. In some embodiments, the water temperature may be from about 20° C. to about 21° C., about 20° C. to about 22° C., about 20° C. to about 23° C., about 20° C. to about 24° C., about 20° C. to about 25° C., about 20° C. to about 26° C., about 20° C. to about 27° C., about 20° C. to about 28° C., about 20° C. to about 29° C., about 20° C. to about 30° C., 20° C. to about 31° C., about 20° C. to about 32° C., about 20° C. to about 33° C., about 20° C. to about 34° C., about 20° C. to about 35° C., about 20° C. to about 36° C., about 20° C. to about 37° C., about 20° C. to about 38° C., about 20° C. to about 39° C., about 20° C. to about 40° C., about 20° C. to about 41° C., about 20° C. to about 42° C., about 20° C. to about 43° C., about 20° C. to about 44° C., about 20° C. to about 45° C., about 20° C. to about 46° C., about 20° C. to about 47° C., about 20° C. to about 48° C., about 20° C. to about 49° C., or about 20° C. to about 50° C. The temperature may be between about 40° C. to about 45° C., about 41° C. to about 45° C., about 42° C. to about 45° C., about 43° C. to about 45° C., or about 44° C. to about 45° C. The warm water may dissolve the nutrient mix efficiently despite the endothermic cooling effect.

The method includes preparing an iodide salt solution by dissolving an iodide salt in water. The water temperature to dissolve the iodide salt and of the resulting iodide salt solution may be room temperature. The temperature may be from about 20° C. to about 45° C. The temperature may be about 21° C. to about 45° C., 22° C. to about 45° C., about 23° C. to about 45° C., about 24° C. to about 45° C., about 25° C. to about 45° C., about 26° C. to about 45° C., about 27° C. to about 45° C., about 28° C. to about 45° C., about 29° C. to about 45° C., about 30° C. to about 45° C., about 31° C. to about 45° C., about 32° C. to about 45° C., about 33° C. to about 45° C., about 34° C. to about 45° C., about 35° C. to about 45° C., about 36° C. to about 45° C., about 37° C. to about 45° C., about 38° C. to about 45° C., about 39° C. to about 45° C., about 40° C. to about 45° C., about 41° C. to about 45° C., about 42° C. to about 45° C., about 43° C. to about 45° C., or about 44° C. to about 45° C. In some embodiments, the temperature may be from about 20° C. to about 21° C., about 20° C. to about 22° C., about 20° C. to about 23° C., about 20° C. to about 24° C., about 20° C. to about 25° C., about 20° C. to about 26° C., about 20° C. to about 27° C., about 20° C. to about 28° C., about 20° C. to about 29° C., about 20° C. to about 30° C., about 20° C. to about 31° C., about 20° C. to about 32° C., about 20° C. to about 33° C., about 20° C. to about 34° C., about 20° C. to about 35° C., about 20° C. to about 36° C., about 20° C. to about 37° C., about 20° C. to about 38° C., about 20° C. to about 39° C., about 20° C. to about 40° C., about 20° C. to about 41° C., about 20° C. to about 42° C., about 20° C. to about 43° C., about 20° C. to about 44° C., or about 20° C. to about 45° C. In some embodiments, the temperature may be about 21° C. to about 25° C., about 22° C. to about 25° C., about 23° C. to about 25° C., or about 24° C. to about 25° C.

The method includes preparing an iodine mixture by adding elemental iodine to the iodide salt solution to form a clear triiodode complex (I₃⁻). The temperature of the iodine mixture may be maintained from about 20° C. to about 45° C. The temperature may be about 21° C. to about 45° C., 22° C. to about 45° C., about 23° C. to about 45° C., about 24° C. to about 45° C., about 25° C. to about 45° C., about 26° C. to about 45° C., about 27° C. to about 45° C., about 28° C. to about 45° C., about 29° C. to about 45° C., about 30° C. to about 45° C., about 31° C. to about 45° C., about 32° C. to about 45° C., about 33° C. to about 45° C., about 34° C. to about 45° C., about 35° C. to about 45° C., about 36° C. to about 45° C., about 37° C. to about 45° C., about 38° C. to about 45° C., about 39° C. to about 45° C., about 40° C. to about 45° C., about 41° C. to about 45° C., about 42° C. to about 45° C., about 43° C. to about 45° C., or bout 44° C. to about 45° C. In some embodiments, the temperature may be from about 20° C. to about 21° C., about 20° C. to about 22° C., about 20° C. to about 23° C., about 20° C. to about 24° C., about 20° C. to about 25° C., about 20° C. to about 26° C., about 20° C. to about 27° C., about 20° C. to about 28° C., about 20° C. to about 29° C., about 20° C. to about 30° C., about 20° C. to about 31° C., about 20° C. to about 32° C., about 20° C. to about 33° C., about 20° C. to about 34° C., about 20° C. to about 35° C., about 20° C. to about 36° C., about 20° C. to about 37° C., about 20° C. to about 38° C., about 20° C. to about 39° C., about 20° C. to about 40° C., about 20° C. to about 41° C., about 20° C. to about 42° C., about 20° C. to about 43° C., about 20° C. to about 44° C., or about 20° C. to about 45° C. In some embodiments, the temperature may be about 21° C. to about 25° C., about 22° C. to about 25° C., about 23° C. to about 25° C., or about 24° C. to about 25° C.

The method includes preparing a nonionic surfactant nutrient solution by adding a nonionic surfactant to the nutrient solution. The temperature of the water when adding the nonionic surfactant to the nutrient solution step may be from about 20° C. to about 50° C. For example, the temperature of the water when adding a nonionic surfactant to the nutrient solution step may be about 21° C. to about 50° C., 22° C. to about 50° C., about 23° C. to about 50° C., about 24° C. to about 50° C., about 25° C. to about 50° C., about 26° C. to about 50° C., about 27° C. to about 50° C., about 28° C. to about 50° C., about 29° C. to about 50° C., about 30° C. to about 50° C., about 31° C. to about 50° C., about 32° C. to about 50° C., about 33° C. to about 50° C., about 34° C. to about 50° C., about 35° C. to about 50° C., about 36° C. to about 50° C., about 37° C. to about 50° C., about 38° C. to about 50° C., about 39° C. to about 50° C., about 40° C. to about 50° C., about 41° C. to about 50° C., about 42° C. to about 50° C., about 43° C. to about 50° C., about 44° C. to about 50° C., about 45° C. to about 50° C., about 46° C. to about 50° C., about 47° C. to about 50° C., about 48° C. to about 50° C., or about 49° C. to about 50° C. In some embodiments, the temperature may be from about 20° C. to about 21° C., about 20° C. to about 22° C., about 20° C. to about 23° C., about 20° C. to about 24° C., about 20° C. to about 25° C., about 20° C. to about 26° C., about 20° C. to about 27° C., about 20° C. to about 28° C., about 20° C. to about 29° C., about 20° C. to about 30° C., about 20° C. to about 31° C., about 20° C. to about 32° C., about 20° C. to about 33° C., about 20° C. to about 34° C., about 20° C. to about 35° C., about 20° C. to about 36° C., about 20° C. to about 37° C., about 20° C. to about 38° C., about 20° C. to about 39° C., about 20° C. to about 40° C., about 20° C. to about 41° C., about 20° C. to about 42° C., about 20° C. to about 43° C., about 20° C. to about 44° C., about 20° C. to about 45° C., about 20° C. to about 46° C., about 20° C. to about 47° C., about 20° C. to about 48° C., about 20° C. to about 49° C., or about 20° C. to about 50° C. In some embodiments, the temperature of the water when adding a nonionic surfactant to the nutrient solution step may be from about 31° C. to about 40° C., 32° C. to about 40° C., about 33° C. to about 40° C., about 34° C. to about 40° C., about 35° C. to about 40° C., about 36° C. to about 40° C., about 37° C. to about 40° C., about 38° C. to about 40° C., about 31° C. to about 40° C., 32° C. to about 40° C., about 33° C. to about 40° C., about 34° C. to about 40° C., about 35° C. to about 40° C., about 36° C. to about 40° C., about 37° C. to about 40° C., about 38° C. to about 40° C., or about 39° C. to about 40° C. In some embodiments, the temperature may be from about 30° C. to about 45° C. The temperature may be from about 30° C. to about 35° C., about 31° C. to about 35° C., about 32° C. to about 35° C., about 33° C. to about 35° C., or about 34° C. to about 35° C.

The last step of the method includes forming the iodophor formulation by combining the nonionic surfactant nutrient solution and the iodine mixture.

In some embodiments of the method, the method includes dissolving one or more nutrients (i.e., micronutrients and/or macronutrients) in water to prepare a nutrient solution; dissolving iodide salt in water to form a iodide salt solution; adding elemental iodine to the iodide salt solution in the water to prepare an iodine mixture; adding a nonionic surfactant to the iodine mixture forming a nonionic surfactant iodine mixture solution; combining the nonionic surfactant iodine mixture solution and the nutrient solution to form the iodophor formulation; and optionally adding an additive.

The pH of the iodophor formulation may be from about 4 to about 8. The pH may be from about 4 to about 8, about 4.1 to about 8, about 4.2 to about 8, about 4.3 to about 8, about 4.4 to about 8, about 4.5 to about 8, about 4.6 to about 8, about 4.7 to about 8, about 4.8 to about 8, about 4.9 to about 8, about 5 to about 8, about 5.1 to about 8, about 5.2 to about 8, about 5.3 to about 8, about 5.4 to about 8, about 5.5 to about 8, about 5.6 to about 8, about 5.7 to about 8, about 5.8 to about 8, about 5.9 to about 8, about 6 to about 8, about 6.1 to about 8, about 6.2 to about 8, about 6.3 to about 8, about 6.4 to about 8, about 6.5 to about 8, about 6.6 to about 8, about 6.7 to about 8, about 6.8 to about 8, about 6.9 to about 8, about 7 to about 8, about 7.1 to about 8, about 7.2 to about 8, about 7.3 to about 8, about 7.4 to about 8, about 7.5 to about 8, about 7.6 to about 8, about 7.7 to about 8, about 7.8 to about 8, or about 7.9 to about 8. In some embodiments, the pH may be from about 4.0 to about 4.1, about 4.0 to about 4.2, about 4.0 to about 4.3, about 4.0 to about 4.4, about 4.0 to about 4.5, about 4.0 to about 4.6, about 4.0 to about 4.7, about 4.0 to about 4.8, about 4.0 to about 4.9, about 4.0 to about 5.0, about 4.0 to about 5.1, about 4.0 to about 5.2, about 4.0 to about 5.3, about 4.0 to about 5.4, about 4.0 to about 5.5, about 4.0 to about 5.6, about 4.0 to about 5.7, about 4.0 to about 5.8, about 4.0 to about 5.9, about 4.0 to about 6.0, about 4.0 to about 6.1, about 4.0 to about 6.2, about 4.0 to about 6.3, about 4.0 to about 6.4, about 4.0 to about 6.5, about 4.0 to about 6.6, about 4.0 to about 6.7, about 4.0 to about 6.8, about 4.0 to about 6.9, about 4.0 to about 7.0, about 4.0 to about 7.1, about 4.0 to about 7.2, about 4.0 to about 7.3, about 4.0 to about 7.4, about 4.0 to about 7.5, about 4.0 to about 7.6, about 4.0 to about 7.7, about 4.0 to about 7.8, about 4.0 to about 7.9, or about 4.0 to about 8.0. In some embodiments, the pH may be from about 4.5 to about 7.5, about 5 to about 7, about 5 to about 6, or about 5.5 to about 6.5. The pH may be adjusted using acids or bases. The pH may be maintained using buffers. Acids include but are not limited to phosphoric acid, lactic acid, nitric acid, acetic acid, citric acid, or any combination thereof. Bases include but are not limited to potassium carbonate, potassium hydroxide, calcium hydroxide, sodium bicarbonate, sodium citrate, or any combination thereof. Buffers include but are not limited to a combination of citric acid/sodium citrate, or phosphoric acid/potassium phosphate, or sodium bicarbonate/carbonic acid. In some embodiments, citric acid may be used to decrease the pH. In some embodiments, sodium citrate may be used to increase the pH. After the addition of the acid or the base, the iodophor solution may be stirred thoroughly. The pH may be maintained for both iodine stability and nutrient compatibility.

The disclosed iodophor formulation may be stably stored for extensive periods of time, e.g., more than two years, when stored in, for example, an amber stained glass or plastic opaque container at room temperature (25° C. to 30° C.) without loss of fungicidal, bactericidal or disinfectant activity.

In some embodiments, the iodide salt may be replaced with an organic acid. The method may include dissolving an organic acid in water to form an organic acid solution, adding elemental iodine to the organic acid solution in the water to prepare an iodine mixture, adding a nonionic surfactant to the iodine mixture forming a nonionic surfactant iodine mixture solution, dissolving one or more nutrients in water to prepare a nutrient solution, and combining the nutrient solution and the nonionic surfactant iodine mixture solution to form the iodophor formulation and optionally adding an additive.

### Method of Using the Iodophor Formulation

The present disclosure is also directed to a method of promoting development of a root and a leaf by promoting the growth of the root and leaf. The method includes treating the root and leaf with the iodophor formulation described above. The iodophor formulation may also be applied to seeds and seedlings/transplants to improve vigor, viability, and promote early growth, by spraying, brushing, washing, immersion, or a combination thereof.

For example, seeds may be treated by diluting 1 to 10 mL (and/or cc) of the iodophor formulation per liter of water and either immersing them for about 5 minutes to about 10 minutes, or by spraying the iodophor formulation directly in a field at the time of transplanting where the diluted solution may be applied directly to the root zone. Seedlings/transplants may be either sprayed in the root zone and/or leaf area before being transplanted, or the root area may be submerged for a maximum of 20 minutes. The treatment may enhance nutrient absorption, root development, germination speed, resistance to stress, or a combination thereof.

The root development may be enhanced resulting in an increase in water and absorption capacity. By applying the iodophor formulation to the plant or seeds, the size of the root area may be increased and thus the plant may cover a greater surface area for water and nutrients. While root structures do not retain much water themselves, they may slow water loss and deep roots may reach deeper water systems helping them stay humid even in dry conditions.

Leaf development may promote larger leaf growth by improving photosynthetic efficiency and energy production. Photosynthetic efficiency may be measured using a Soil Plant Analysis Development meter (SPAD) meter. A SPAD meter is a handheld device used to measure the chlorophyll content in plant leaves. Chlorophyll is crucial for photosynthesis, and its content is an important indicator of plant health and nutrient status, particularly nitrogen levels. The SPAD meter works by assessing the light absorbance properties of the leaf, specifically how much light is absorbed by the chlorophyll.

The present disclosure is further directed to a method of increasing photosynthetic efficiency of a crop. The method includes treating the root and leaf with the iodophor formulation described above.

The present disclosure is further directed to a method of improving yield of a crop. The method includes treating the root and leaf with the iodophor formulation described above.

The iodophor formulation may be compatible with common agricultural equipment (e.g., sprayers, irrigation systems) and can be easily integrated into existing farming workflows.

Treatment with the disclosed iodophor formulation may be accomplished using a variety of methods such as spraying, brushing, washing, immersion, or a combination thereof.

The disclosed iodophor formulation may be used in its original concentration or by diluting in water by brushing or by any other application method directly to the trunk and branches of trees. Pruning cuts and other bark openings may also be treated with the disclosed iodophor formulation without any phytotoxic effects. These types of treatment are rapidly effective.

The application rate of the disclosed iodophor formulation may be from about 0.2 to about 10 liters of the disclosed iodophor formulation per hectare (L/ha). The application rate of the iodophor formulation may be from about 0.2 L/ha to about 10 L/ha, about 0.3 L/ha to about 10 L/ha, about 0.4 L/ha to about 10 L/ha, about 0.5 L/ha to about 10 L/ha, about 0.6 L/ha to about 10 L/ha, about 0.7 L/ha to about 10 L/ha, about 0.8 L/ha to about 10 L/ha, about 0.9 L/ha to about 10 L/ha, about 1.0 L/ha to about 10 L/ha, about 1.1 L/ha to about 10 L/ha, about 1.2 L/ha to about 10 L/ha, about 1.3 L/ha to about 10 L/ha, about 1.4 L/ha to about 10 L/ha, about 1.5 L/ha to about 10 L/ha, about 1.6 L/ha to about 10 L/ha, about 1.7 L/ha to about 10 L/ha, about 1.8 L/ha to about 10 L/ha, about 1.9 L/ha to about 10 L/ha, about 2.0 L/ha to about 10 L/ha, about 2.1 L/ha to about 10 L/ha, about 2.2 L/ha to about 10 L/ha, about 2.3 L/ha to about 10 L/ha, about 2.4 L/ha to about 10 L/ha, about 2.5 L/ha to about 10 L/ha, about 2.6 L/ha to about 10 L/ha, about 2.7 L/ha to about 10 L/ha, about 2.8 L/ha to about 10 L/ha, about 2.9 L/ha to about 10 L/ha, about 3.0 L/ha to about 10 L/ha, about 3.1 L/ha to about 10 L/ha, about 3.2 L/ha to about 10 L/ha, about 3.3 L/ha to about 10 L/ha, about 3.4 L/ha to about 10 L/ha, about 3.5 L/ha to about 10 L/ha, about 3.6 L/ha to about 10 L/ha, about 3.7 L/ha to about 10 L/ha, about 3.8 L/ha to about 10 L/ha, about 3.9 L/ha to about 10 L/ha, about 4.0 L/ha to about 10 L/ha, about 4.1 L/ha to about 10 L/ha, about 4.2 L/ha to about 10 L/ha, about 4.3 L/ha to about 10 L/ha, about 4.4 L/ha to about 10 L/ha, about 4.5 L/ha to about 10 L/ha, about 4.6 L/ha to about 10 L/ha, about 4.7 L/ha to about 10 L/ha, about 4.8 L/ha to about 10 L/ha, about 4.9 L/ha to about 10 L/ha, about 5.0 L/ha to about 10 L/ha, about 5.1 L/ha to about 10 L/ha, about 5.2 L/ha to about 10 L/ha, about 5.3 L/ha to about 10 L/ha, about 5.4 L/ha to about 10 L/ha, about 5.5 L/ha to about 10 L/ha, about 5.6 L/ha to about 10 L/ha, about 5.7 L/ha to about 10 L/ha, about 5.8 L/ha to about 10 L/ha, about 5.9 L/ha to about 10 L/ha, about 6.0 L/ha to about 10 L/ha, about 6.1 L/ha to about 10 L/ha, about 6.2 L/ha to about 10 L/ha, about 6.3 L/ha to about 10 L/ha, about 6.4 L/ha to about 10 L/ha, about 6.5 L/ha to about 10 L/ha, about 6.6 L/ha to about 10 L/ha, about 6.7 L/ha to about 10 L/ha, about 6.8 L/ha to about 10 L/ha, about 6.9 L/ha to about 10 L/ha, about 7.0 L/ha to about 10 L/ha, about 7.1 L/ha to about 10 L/ha, about 7.2 L/ha to about 10 L/ha, about 7.3 L/ha to about 10 L/ha, about 7.4 L/ha to about 10 L/ha, about 7.5 L/ha to about 10 L/ha, about 7.6 L/ha to about 10 L/ha, about 7.7 L/ha to about 10 L/ha, about 7.8 L/ha to about 10 L/ha, about 7.9 L/ha to about 10 L/ha, about 8.0 L/ha to about 10 L/ha, about 8.1 L/ha to about 10 L/ha, about 8.2 L/ha to about 10 L/ha, about 8.3 L/ha to about 10 L/ha, about 8.4 L/ha to about 10 L/ha, about 8.5 L/ha to about 10 L/ha, about 8.6 L/ha to about 10 L/ha, about 8.7 L/ha to about 10 L/ha, about 8.8 L/ha to about 10 L/ha, about 8.9 L/ha to about 10 L/ha, about 9.0 L/ha to about 10 L/ha, about 9.1 L/ha to about 10 L/ha, about 9.2 L/ha to about 10 L/ha, about 9.3 L/ha to about 10 L/ha, about 9.4 L/ha to about 10 L/ha, about 9.5 L/ha to about 10 L/ha, about 9.6 L/ha to about 10 L/ha, about 9.7 L/ha to about 10 L/ha, about 9.8 L/ha to about 10 L/ha, about 9.9 L/ha to about 10 L/ha, about 1 L/ha to about 5 L/ha, about 1.1 to about 5 L/ha, about 1.2 L/ha to about L/ha, about 1.3 L/ha to about 5 L/ha, about 1.4 to about 5 L/ha, about 1.5 L/ha to about 5 L/ha, about 1.6 L/ha to about 5 L/ha, about 1.7 to about 5 L/ha, about 1.8 L/ha to about L/ha, about 1.9 L/ha to about 5 L/ha, about 2 L/ha to about 5 L/ha, about 2.1 to about 5 L/ha, about 2.2 L/ha to about L/ha, about 2.3 L/ha to about 5 L/ha, about 2.4 to about 5 L/ha, about 2.5 L/ha to about 5 L/ha, about 2.6 L/ha to about 5 L/ha, about 2.7 to about 5 L/ha, about 2.8 L/ha to about L/ha, about 2.9 L/ha to about 5 L/ha, about 3 L/ha to about 5 L/ha, about 3.1 to about 5 L/ha, about 3.2 L/ha to about L/ha, about 3.3 L/ha to about 5 L/ha, about 3.4 to about 5 L/ha, about 3.5 L/ha to about L/ha, about 3.6 L/ha to about 5 L/ha, about 3.7 to about 5 L/ha, about 3.8 L/ha to about L/ha, about 3.9 L/ha to about 5 L/ha, about 4 L/ha to about 5 L/ha, about 4.1 to about 5 L/ha, about 4.2 L/ha to about L/ha, about 4.3 L/ha to about 5 L/ha, about 4.4 to about 5 L/ha, about 4.5 L/ha to about 5 L/ha, about 4.6 L/ha to about 5 L/ha, about 4.7 to about 5 L/ha, about 4.8 L/ha to about L/ha, about 4.9 L/ha to about 5 L/ha, about 1.5 L/ha to about 4.5 L/ha, about 2 to about 4 L/ha, or about 2.5 L/ha to about 3.5 L/ha. In some embodiments, the application rate may be from about 0.2 L/ha to about 0.3 L/ha, about 0.2 L/ha to about 0.4 L/ha, about 0.2 L/ha to about 0.5 L/ha, about 0.2 L/ha to about 0.6 L/ha, about 0.2 L/ha to about 0.7 L/ha, about 0.2 L/ha to about 0.8 L/ha, about 0.2 L/ha to about 0.9 L/ha, about 0.2 L/ha to about 1.0 L/ha, about 0.2 L/ha to about 1.1 L/ha, about 0.2 L/ha to about 1.2 L/ha, about 0.2 L/ha to about 1.3 L/ha, about 0.2 L/ha to about 1.4 L/ha, about 0.2 L/ha to about 1.5 L/ha, about 0.2 L/ha to about 1.6 L/ha, about 0.2 L/ha to about 1.7 L/ha, about 0.2 L/ha to about 1.8 L/ha, about 0.2 L/ha to about 1.9 L/ha, about 0.2 L/ha to about 2.0 L/ha, about 0.2 L/ha to about 2.1 L/ha, about 0.2 L/ha to about 2.2 L/ha, about 0.2 L/ha to about 2.3 L/ha, about 0.2 L/ha to about 2.4 L/ha, about 0.2 L/ha to about 2.5 L/ha, about 0.2 L/ha to about 2.6 L/ha, about 0.2 L/ha to about 2.7 L/ha, about 0.2 L/ha to about 2.8 L/ha, about 0.2 L/ha to about 2.9 L/ha, about 0.2 L/ha to about 3.0 L/ha, about 0.2 L/ha to about 3.1 L/ha, about 0.2 L/ha to about 3.2 L/ha, about 0.2 L/ha to about 3.3 L/ha, about 0.2 L/ha to about 3.4 L/ha, about 0.2 L/ha to about 3.5 L/ha, about 0.2 L/ha to about 3.6 L/ha, about 0.2 L/ha to about 3.7 L/ha, about 0.2 L/ha to about 3.8 L/ha, about 0.2 L/ha to about 3.9 L/ha, about 0.2 L/ha to about 4.0 L/ha, about 0.2 L/ha to about 4.1 L/ha, about 0.2 L/ha to about 4.2 L/ha, about 0.2 L/ha to about 4.3 L/ha, about 0.2 L/ha to about 4.4 L/ha, about 0.2 L/ha to about 4.5 L/ha, about 0.2 L/ha to about 4.6 L/ha, about 0.2 L/ha to about 4.7 L/ha, about 0.2 L/ha to about 4.8 L/ha, about 0.2 L/ha to about 4.9 L/ha, about 0.2 L/ha to about 5.0 L/ha, about 0.2 L/ha to about 5.1 L/ha, about 0.2 L/ha to about 5.2 L/ha, about 0.2 L/ha to about 5.3 L/ha, about 0.2 L/ha to about 5.4 L/ha, about 0.2 L/ha to about 5.5 L/ha, about 0.2 L/ha to about 5.6 L/ha, about 0.2 L/ha to about 5.7 L/ha, about 0.2 L/ha to about 5.8 L/ha, about 0.2 L/ha to about 5.9 L/ha, about 0.2 L/ha to about 6.0 L/ha, about 0.2 L/ha to about 6.1 L/ha, about 0.2 L/ha to about 6.2 L/ha, about 0.2 L/ha to about 6.3 L/ha, about 0.2 L/ha to about 6.4 L/ha, about 0.2 L/ha to about 6.5 L/ha, about 0.2 L/ha to about 6.6 L/ha, about 0.2 L/ha to about 6.7 L/ha, about 0.2 L/ha to about 6.8 L/ha, about 0.2 L/ha to about 6.9 L/ha, about 0.2 L/ha to about 7.0 L/ha, about 0.2 L/ha to about 7.1 L/ha, about 0.2 L/ha to about 7.2 L/ha, about 0.2 L/ha to about 7.3 L/ha, about 0.2 L/ha to about 7.4 L/ha, about 0.2 L/ha to about 7.5 L/ha, about 0.2 L/ha to about 7.6 L/ha, about 0.2 L/ha to about 7.7 L/ha, about 0.2 L/ha to about 7.8 L/ha, about 0.2 L/ha to about 7.9 L/ha, about 0.2 L/ha to about 8.0 L/ha, about 0.2 L/ha to about 8.1 L/ha, about 0.2 L/ha to about 8.2 L/ha, about 0.2 L/ha to about 8.3 L/ha, about 0.2 L/ha to about 8.4 L/ha, about 0.2 L/ha to about 8.5 L/ha, about 0.2 L/ha to about 8.6 L/ha, about 0.2 L/ha to about 8.7 L/ha, about 0.2 L/ha to about 8.8 L/ha, about 0.2 L/ha to about 8.9 L/ha, about 0.2 L/ha to about 9.0 L/ha, about 0.2 L/ha to about 9.1 L/ha, about 0.2 L/ha to about 9.2 L/ha, about 0.2 L/ha to about 9.3 L/ha, about 0.2 L/ha to about 9.4 L/ha, about 0.2 L/ha to about 9.5 L/ha, about 0.2 L/ha to about 9.6 L/ha, about 0.2 L/ha to about 9.7 L/ha, about 0.2 L/ha to about 9.8 L/ha, about 0.2 L/ha to about 9.9 L/ha, or about 0.2 L/ha to about 10.0 L/ha. In some embodiments, the application rate may be from about 1.5 L/ha to about 3 L/ha.

The iodophor formulation may be further diluted to about 0.1% (v/v) to 90% (v/v) of the disclosed iodophor formulation in water for application. For example, the aqueous solution may have from about 0.1% (v/v) to about 90% (v/v), about 0.2% (v/v) to about 90% v/v, about 0.3% (v/v) to about 90% v/v, about 0.4% (v/v) to about 90% v/v, about 0.5% (v/v) to about 90% v/v, about 0.6% (v/v) to about 90% v/v, about 0.7% (v/v) to about 90% v/v, about 0.8% (v/v) to about 90% v/v, about 0.9% (v/v) to about 90% v/v, about 1.0% (v/v) to about 90% v/v, about 1.1% (v/v) to about 90% v/v, about 1.2% (v/v) to about 90% v/v, about 1.3% (v/v) to about 90% v/v, about 1.4% (v/v) to about 90% v/v, about 1.5% (v/v) to about 90% v/v, about 1.6% (v/v) to about 90% v/v, about 1.7% (v/v) to about 90% v/v, about 1.8% (v/v) to about 90% v/v, about 1.9% (v/v) to about 90% v/v, about 2% (v/v) to about 90% v/v, about 3% (v/v) to about 90% (v/v), about 4% (v/v) to about 90% (v/v), about 5% (v/v) to about 90% (v/v), about 6% (v/v) to about 90% (v/v), about 7% (v/v) to about 90% (v/v), about 8% (v/v) to about 90% (v/v), about 9% (v/v) to about 90% (v/v), about 10% (v/v) to about 90% (v/v), about 11% (v/v) to about 90% (v/v), about 12% (v/v) to about 90% (v/v), about 13% (v/v) to about 90% (v/v), about 14% (v/v) to about 90% (v/v), about 15% (v/v) to about 90% (v/v), about 16% (v/v) to about 90% (v/v), about 17% (v/v) to about 90% (v/v), about 18% (v/v) to about 90% (v/v), about 19% (v/v) to about 90% (v/v), about 20% (v/v) to about 90% (v/v), about 21% (v/v) to about 90% (v/v), about 22% (v/v) to about 90% (v/v), 23% (v/v) to about 90% (v/v), about 24% (v/v) to about 90% (v/v), about 25% (v/v) to about 90% (v/v), about 26% (v/v) to about 90% (v/v), about 27% (v/v) to about 90% (v/v), about 28% (v/v) to about 90% (v/v), about 29% (v/v) to about 90% (v/v), about 30% (v/v) to about 90% (v/v), about 31% (v/v) to about 90% (v/v), about 32% (v/v) to about 90% (v/v), about 33% (v/v) to about 90% (v/v), about 34% (v/v) to about 90% (v/v), about 35% (v/v) to about 90% (v/v), about 36% (v/v) to about 90% (v/v), about 37% (v/v) to about 90% (v/v), about 38% (v/v) to about 90% (v/v), about 39% (v/v) to about 90% (v/v), about 40% (v/v) to about 90% (v/v), about 41% (v/v) to about 90% (v/v), about 42% (v/v) to about 90% (v/v), 43% (v/v) to about 90% (v/v), about 44% (v/v) to about 90% (v/v), about 45% (v/v) to about 90% (v/v), about 46% (v/v) to about 90% (v/v), about 47% (v/v) to about 90% (v/v), about 48% (v/v) to about 90% (v/v), about 49% (v/v) to about 90% (v/v), about 50% (v/v) to about 90% (v/v), about 51% (v/v) to about 90% (v/v), about 52% (v/v) to about 90% (v/v), about 53% (v/v) to about 90% (v/v), about 54% (v/v) to about 90% (v/v), about 55% (v/v) to about 90% (v/v), about 56% (v/v) to about 90% (v/v), about 57% (v/v) to about 90% (v/v), about 58% (v/v) to about 90% (v/v), about 59% (v/v) to about 90% (v/v), about 60% (v/v) to about 90% (v/v), about 61% (v/v) to about 90% (v/v), about 62% (v/v) to about 90% (v/v), 63% (v/v) to about 90% (v/v), about 64% (v/v) to about 90 (v/v), about 65% (v/v) to about 90% (v/v), about 66% (v/v) to about 90% (v/v), about 67% (v/v) to about 90% (v/v), about 68% (v/v) to about 90% (v/v), about 69% (v/v) to about 90% (v/v), about 70% (v/v) to about 90% (v/v), about 71% (v/v) to about 90% (v/v), about 72% (v/v) to about 90% (v/v), about 73% (v/v) to about 90% (v/v), about 74% (v/v) to about 90% (v/v), about 75% (v/v) to about 90% (v/v), about 76% (v/v) to about 90% (v/v), about 77% (v/v) to about 90% (v/v), about 78% (v/v) to about 90% (v/v), about 79% (v/v) to about 90% (v/v), about 80% (v/v) to about 90% (v/v), about 81% (v/v) to about 90% (v/v), about 82% (v/v) to about 90% (v/v), 83% (v/v) to about 90% (v/v), about 84% (v/v) to about 90% (v/v), about 85% (v/v) to about 90% (v/v), about 86% (v/v) to about 90% (v/v), about 87% (v/v) to about 90% (v/v), about 88% (v/v) to about 90% (v/v), or about 89% (v/v) to about 90% (v/v) of the disclosed iodophor formulation. In some embodiments, the aqueous solution may have from about 0.5% (v/v) to about 95% (v/v), about 1.0% (v/v) to about 90% (v/v), about 1.5% (v/v) to about 85% (v/v), about 2.0% (v/v) to about 80% (v/v), about 2.5% (v/v) to about 75% (v/v), about 3.0% (v/v) to about 70% (v/v), about 3.5% (v/v) to about 65% (v/v), about 4.0% (v/v) to about 60% (v/v), about 4.5% (v/v) to about 55% (v/v), about 5.0% (v/v) to about 50% (v/v), about 5.5% (v/v) to about 45% (v/v), about 6.0% (v/v) to about 40% (v/v), about 6.5% (v/v) to about 35% (v/v), about 7.0% (v/v) to about 30% (v/v), about 7.5% (v/v) to about 25% (v/v), about 8.0% (v/v) to about 20% (v/v), about 8.5% (v/v) to about 15% (v/v), about 9.0% (v/v) to about 10% (v/v), or about 2% (v/v) to about 5% (v/v) of the disclosed iodophor formulation. In some embodiments, the aqueous solution may have from about 0.1% (v/v) to about 0.2% (v/v), about 0.1% (v/v) to about 0.3% (v/v), about 0.1% (v/v) to about 0.4% (v/v), about 0.1% (v/v) to about 0.5% (v/v), about 0.1% (v/v) to about 0.6% (v/v), about 0.1% (v/v) to about 0.7% (v/v), about 0.1% (v/v) to about 0.8% (v/v), about 0.1% (v/v) to about 0.9% (v/v), about 0.1% (v/v) to about 1.0% (v/v), about 0.1% (v/v) to about 2.0% (v/v), about 0.1% (v/v) to about 3.0% (v/v), about 0.1% (v/v) to about 4.0% (v/v), about 0.1% (v/v) to about 5.0% (v/v), about 0.1% (v/v) to about 6.0% (v/v), about 0.1% (v/v) to about 7.0% (v/v), about 0.1% (v/v) to about 8.0% (v/v), about 0.1% (v/v) to about 9.0% (v/v), about 0.1% (v/v) to about 10.0% (v/v), about 0.1% (v/v) to about 11.0% (v/v), about 0.1% (v/v) to about 12.0% (v/v), about 0.1% (v/v) to about 13.0% (v/v), about 0.1% (v/v) to about 14.0% (v/v), about 0.1% (v/v) to about 15.0% (v/v), about 0.1% (v/v) to about 16.0% (v/v), about 0.1% (v/v) to about 17.0% (v/v), about 0.1% (v/v) to about 18.0% (v/v), about 0.1% (v/v) to about 19.0% (v/v), about 0.1% (v/v) to about 20.0% (v/v), about 0.1% (v/v) to about 21.0% (v/v), about 0.1% (v/v) to about 22.0% (v/v), about 0.1% (v/v) to about 23.0% (v/v), about 0.1% (v/v) to about 24.0% (v/v), about 0.1% (v/v) to about 25.0% (v/v), about 0.1% (v/v) to about 26.0% (v/v), about 0.1% (v/v) to about 27.0% (v/v), about 0.1% (v/v) to about 28.0% (v/v), about 0.1% (v/v) to about 29.0% (v/v), about 0.1% (v/v) to about 30.0% (v/v), about 0.1% (v/v) to about 31.0% (v/v), about 0.1% (v/v) to about 32.0% (v/v), about 0.1% (v/v) to about 33.0% (v/v), about 0.1% (v/v) to about 34.0% (v/v), about 0.1% (v/v) to about 35.0% (v/v), about 0.1% (v/v) to about 36.0% (v/v), about 0.1% (v/v) to about 37.0% (v/v), about 0.1% (v/v) to about 38.0% (v/v), about 0.1% (v/v) to about 39.0% (v/v), about 0.1% (v/v) to about 40.0% (v/v), about 0.1% (v/v) to about 41.0% (v/v), about 0.1% (v/v) to about 42.0% (v/v), about 0.1% (v/v) to about 43.0% (v/v), about 0.1% (v/v) to about 44.0% (v/v), about 0.1% (v/v) to about 45.0% (v/v), about 0.1% (v/v) to about 46.0% (v/v), about 0.1% (v/v) to about 47.0% (v/v), about 0.1% (v/v) to about 48.0% (v/v), about 0.1% (v/v) to about 49.0% (v/v), about 0.1% (v/v) to about 50.0% (v/v), about 0.1% (v/v) to about 51.0% (v/v), about 0.1% (v/v) to about 52.0% (v/v), about 0.1% (v/v) to about 53.0% (v/v), about 0.1% (v/v) to about 54.0% (v/v), about 0.1% (v/v) to about 55.0% (v/v), about 0.1% (v/v) to about 56.0% (v/v), about 0.1% (v/v) to about 57.0% (v/v), about 0.1% (v/v) to about 58.0% (v/v), about 0.1% (v/v) to about 59.0% (v/v), about 0.1% (v/v) to about 60.0% (v/v), about 0.1% (v/v) to about 61.0% (v/v), about 0.1% (v/v) to about 62.0% (v/v), about 0.1% (v/v) to about 63.0% (v/v), about 0.1% (v/v) to about 64.0% (v/v), about 0.1% (v/v) to about 65.0% (v/v), about 0.1% (v/v) to about 66.0% (v/v), about 0.1% (v/v) to about 67.0% (v/v), about 0.1% (v/v) to about 68.0% (v/v), about 0.1% (v/v) to about 69.0% (v/v), about 0.1% (v/v) to about 70.0% (v/v), about 0.1% (v/v) to about 71.0% (v/v), about 0.1% (v/v) to about 72.0% (v/v), about 0.1% (v/v) to about 73.0% (v/v), about 0.1% (v/v) to about 74.0% (v/v), about 0.1% (v/v) to about 75.0% (v/v), about 0.1% (v/v) to about 76.0% (v/v), about 0.1% (v/v) to about 77.0% (v/v), about 0.1% (v/v) to about 78.0% (v/v), about 0.1% (v/v) to about 79.0% (v/v), about 0.1% (v/v) to about 80.0% (v/v), about 0.1% (v/v) to about 81.0% (v/v), about 0.1% (v/v) to about 82.0% (v/v), about 0.1% (v/v) to about 83.0% (v/v), about 0.1% (v/v) to about 84.0% (v/v), about 0.1% (v/v) to about 85.0% (v/v), about 0.1% (v/v) to about 86.0% (v/v), about 0.1% (v/v) to about 87.0% (v/v), about 0.1% (v/v) to about 88.0% (v/v), about 0.1% (v/v) to about 89.0% (v/v), about 0.1% (v/v) to about 90.0% (v/v), about 0.1% (v/v) to about 91.0% (v/v), about 0.1% (v/v) to about 92.0% (v/v), about 0.1% (v/v) to about 93.0% (v/v), about 0.1% (v/v) to about 94.0% (v/v), about 0.1% (v/v) to about 95.0% (v/v), about 0.1% (v/v) to about 96.0% (v/v), about 0.1% (v/v) to about 97.0% (v/v), about 0.1% (v/v) to about 98.0% (v/v), about 0.1% (v/v) to about 99.0% (v/v), or about 0.1% (v/v) to about 100.0% (v/v).

The disclosed iodophor formulation may be quickly absorbed through the leaves and bark of trees without danger of being washed out by rain, even if it rains about 3 to 4 hours after application. In addition, since there is no reduction of free iodine in the disclosed iodophor formulation, there may be no danger of phytotoxic effects.

When combined with insecticides or fungicides, the iodophor formulation may enhance the effectiveness of the insecticides or fungicides. The increase in their effectiveness may reduce the required dosage of the insecticides or fungicides. The iodophor formulation may also assist other chemical and organic products.

The following examples are illustrative of the present invention and are in no way intended to limit the scope thereof.

### EXAMPLES

### Example 1: Series of Field Trials Conducted in Monte Buey (Córdoba Province, Argentina) to Evaluate the Effects of the Disclosed Iodophor Formulation Acting as a Foliar Bio Stimulant Denominated “BIO Q” in the Crops of Soybeans, Corn (Both Early and Late Planting), and Sorghum Across Two Seasons: 2022/23 and 2023/24

The composition of formulation 1 tested is provided in Table 1.

| Component | Weight percent (%) |
|---|---|
| Non-ionic Surfactant | 11.12 |
| Metallic iodine | 0.52 |
| Potassium iodide | 0.58 |
| Nitrogen | 4.48 |
| Phosphorus | 4.48 |
| Potassium (K₂O) | 4.48 |
| Manganese (Mn | 0.0112 |
| Iron (Fe): | 0.0224 |
| Zinc (Zn) | 0.0112 |
| Copper (Cu) | 0.0112 |
| Boron (B) | 0.00448 |
| Molybdenum (Mo) | 0.00112 |
| Water | 65.38 |

The experimental design used randomized blocks with three replicates. The plot size was approximately 2.1 m wide by 10 m long.

The primary objective was to determine 1) the effects of different doses (750, 1000, and 1500 cm³/ha); 2) the impact of different numbers of applications (1, 2, 3, or 4); and 3) the crop yield performance.

### Application Methodology

The timing of applications for corn and sorghum included four applications at V4, V6, V8, and V10; three applications at V4, V6, and V8; two applications at V4 and V6; and one application at V4.

The timing of applications for soybeans will include four applications at V6, R1, R3, and R5; three applications at V6, R1, and R3; two applications at V6 and R1; and one application at V6.

The spraying conditions were backpack sprayer at 100 L/ha and 2.5 bar pressure.

The evaluated variables were grain yield (kg/ha) and standardized to a base moisture.

### Environmental Characterization of Each Season

### 2022/23 Season

Marked drought conditions (third consecutive “La Nina” event).
Rainfall 50% below historical averages.
Intense heat stress (especially in January).
Test-yield plots produced up to 30-50% less than usual in the area.

### 2023/24 Season

Rainfall levels close to normal, with better distribution.
Good growing and yield conditions around or above area historic averages.

### Results and Analysis by Crop

### Soybeans

### 2022/23 Season:

Control yields: −2945 kg/ha (40% below typical regional levels).
Significant yield increases in most treatments (1, 2, and 3 applications).
2 applications at 1000-1500 cm³/ha gave the best results, with 30-33% increases over control.
4 applications yielded below control.

### 2023/24 Season:

Control yields: −3873 kg/ha (close to the local average).
All treatments exceeded control.
The best outcome was 2 applications at 1000 cm³/ha, showing significant increase.
4 applications did not reduce yields (contrary to the previous cycle).

### Corn

### 2022/23 Season:

Control yields: −6065 kg/ha (53% below average).
All treatments exceeded control.
1 and 2 applications at 1500 cm³/ha resulted in gains of 14-19%.

### 2023/24 Season:

Control yields: ~12,642 kg/ha (slightly above average).
All treatments outperformed control.
The best outcome was 3 applications at 750 cm³/ha, achieving 13,696 kg/ha an 8.34% increase over control.

### Sorghum

### 2022/23 Season:

Control yields: −5426 kg/ha (30% below normal).
1, 2, and 3 applications showed yield improvements.
4 applications depressed yield at 750 cm³/ha.

### 2023/24 Season:

Control yields: −6522 kg/ha (normal for the area).
Of the 12 treatments evaluated, 11 outperformed control.

Summary of Yield Increments in provided in Table 2.

TABLE 2

| Season | Crop | Yield Gains |
|---|---|---|
| 2022/23 | Soybeans | +33% |
| 2022/23 | Corn | +19% |
| 2022/23 | Sorghum | +30% |
| 2023/24 | Soybeans | +13% |
| 2023/24 | Corn | +8% |
| 2023/24 | Sorghum | +13% |

### CONCLUSIONS

Impact of Climate Conditions: In the more challenging 2022/23 season, yield gains from the iodophor formulation were notably higher, reflecting its strength in mitigating stress-related losses. In 2023/24, although environmental conditions were favorable, the iodophor composition continued to deliver robust yield improvements, demonstrating its consistent efficacy across diverse scenarios.

Number of Applications: Two applications emerged as the best approach for soybeans and corn. In drought conditions, four applications occasionally depressed yield. In sorghum, three applications yielded the best results.

Dose & Rates: Higher doses (1000-1500 cm³/ha) typically corresponded to greater yield increases, although, in corn 2023/24, a lower dose (750 cm³/ha) with more applications gave the best result. Optimal strategies will depend on crop species, water availability, and yearly conditions.

Numerous examples are provided herein to enhance the understanding of the present disclosure. A specific set of statements are provided as follows.

Statement 1: An iodophor formulation comprising an iodine mixture, a nonionic surfactant, a macronutrient, a chelated micronutrient. and an agriculturally acceptable liquid carrier or diluent.

Statement 2: The iodophor formulation of statement 1, wherein the agriculturally acceptable liquid carrier or diluent is water.

Statement 3: The iodophor formulation of statement 1 or 2, further comprising an additive.

Statement 4: The iodophor formulation of statement 3, wherein the additive comprises a humectant, an amphoteric surfactant, or a combination thereof.

Statement 5: The iodophor formulation of statement 4, wherein the humectant comprises propylene glycol, glycerin, or a combination thereof.

Statement 6: The iodophor formulation of statement 4 or 5, wherein the amphoteric surfactant comprises cocamidopropyl betaine.

Statement 7: The iodophor formulation of any one of statements 1-6, wherein the iodine mixture comprises a potassium iodide (KI) and an elemental iodine (I₂).

Statement 8: The iodophor formulation of statement 7, wherein the elemental iodine and the potassium iodide are present in a weight ratio (I₂:KI) from about 0.5:1 to about 1:1.

Statement 9: The iodophor formulation of statement 8, wherein the elemental iodine and potassium iodide are present in the weight ratio of about 0.9:1.

Statement 10: The iodophor formulation of any one of statements 1-9, wherein the nonionic surfactant and the iodine mixture are present in a weight ratio from about 3:1 to 40:1.

Statement 11: The iodophor formulation of statement 10, wherein the nonionic surfactant and the iodine mixture are present in the weight ratio of about 20:1.

Statement 12: The iodophor formulation of any one of statements 1-11, wherein the macronutrient is present in the iodophor formulation in an amount from about 1% to about 25% by weight.

Statement 13: The iodophor formulation of any one of statements 1-12, wherein the chelated micronutrient is present in the iodophor formulation from about 0.0001% to about 1% by weight.

Statement 14: The iodophor formulation of any one of statements 1-13, wherein the nonionic surfactant comprises an alkyl polyglucoside, an alcohol ethoxylate, a nonylphenol ethoxylate, a polyoxyethylene sorbitan ester, a silicon based nonionic surfactant, a betaine, or any combination thereof.

Statement 15: The iodophor formulation of statement 14, wherein the alkyl polyglucoside comprises sunflower glucoside, coco-glucoside, decyl glucoside, lauryl glucoside, capryl glucoside, or a combination thereof.

Statement 16: The iodophor formulation of statement 14 or 15, wherein the alcohol ethoxylate comprises from 1 to 50 ethylene oxide units.

Statement 17: The iodophor formulation of any one of statements 14-16, wherein the nonylphenol ethoxylate comprises from 1 to 50 ethylene oxide units.

Statement 18: The iodophor formulation of any one of statements 14-17, wherein the polyoxyethylene sorbitan ester comprises polysorbate 20, polysorbate 40, polysorbate 60, polysorbate 80, or combinations thereof.

Statement 19: The iodophor formulation of any one of statements 1-18, wherein the macronutrient comprises any one of magnesium, calcium, nitrogen, diphosphorous pentoxide, potassium oxide, or a combination thereof.

Statement 20: The iodophor formulation of statement 19, wherein the nitrogen is present in the iodophor formulation in an amount from about 1% to about 25% by weight.

Statement 21: The iodophor formulation of statement 19, wherein the diphosphorous pentoxide is present in the iodophor formulation in an amount from about 1% to about 25% by weight.

Statement 22: The iodophor formulation of statement 19 or 20, wherein the potassium oxide is present in the iodophor formulation in an amount from about 1% to about 25% by weight.

Statement 23: The iodophor formulation of any one of statements 1-22, wherein the chelated micronutrient comprises at least one of manganese, iron, zinc, copper, boron, molybdenum, or a combination thereof.

Statement 24: The iodophor formulation of statement 23, wherein the manganese is present in the iodophor formulation in an amount from about 0.0001% to about 0.1% by weight.

Statement 25: The iodophor formulation of statement 23 or 24, wherein the iron is present in the iodophor formulation in an amount from about 0.0001% to about 0.2% by weight.

Statement 26: The iodophor formulation of any one of statements 23-25, wherein the zinc is present in the iodophor formulation in an amount from about 0.0001% to about 0.1% by weight.

Statement 27: The iodophor formulation of any one of statements 23-26, wherein the copper is present in the iodophor formulation in an amount from about 0.0001% to about 0.1% by weight.

Statement 28: The iodophor formulation of any one of statements 23-27, wherein the boron is present in the iodophor formulation in an amount from about 0.0001% to about 0.05% by weight.

Statement 29: The iodophor formulation of any one of statements 23-28, wherein the molybdenum is present in the iodophor formulation in an amount from about 0.001% to about 0.01% by weight.

Statement 30: A method of preparing an iodophor formulation, the method comprising dissolving a micronutrient and a chelated micronutrient in water to prepare a nutrient solution; dissolving potassium iodide in water and adding iodine to the potassium iodide in the water to prepare an iodine mixture; adding a nonionic surfactant to the nutrient solution forming a nonionic surfactant nutrient solution; and combining the nonionic surfactant nutrient solution and the iodine mixture to form the iodophor formulation.

Statement 31: The method of statement 30, further comprising adding an additive.

Statement 32: The method of statement 31, wherein the additive comprises propylene glycol, glycerin, cocamidopropyl betaine, monosilicic acid or a combination thereof.

Statement 33: The method of any one of statements 30-32, wherein temperature of the water in the dissolving the micronutrient and the chelated micronutrient step is maintained at about 40° C. to about 45° C.

Statement 34: The method of any one of statements 30-33, wherein temperature of the water in the adding the nonionic surfactant to the nutrient solution step is maintained at about 30° C. to about 35° C.

Statement 35: The method of any one of statements 30-34, wherein pH of the iodophor formulation is about 4 to about 8.

Statement 36: A method of increasing photosynthetic efficiency of a crop, the method comprising treating the crop with the iodophor formulation of any one of statements 1-29.

Statement 37: The method of statement 36, wherein treating the crop comprises spraying the iodophor formulation onto leaves of the crop.

Statement 38: The method of statement 36 or 37, wherein the crop comprises a fruit, a grain, or a vegetable.

Statement 39: The method of any one of statements 36-38, wherein the crop comprises coffee trees or citrus trees.

Statement 40: A method of promoting development of a root and leaf, the method comprising treating the root and leaf with the iodophor formulation of any one of statements 1-29.

Statement 41: A method of improving yield of a crop, the method comprising treating the crop with the iodophor formulation of any one of statements 1-29.

What is claimed is:

1. An iodophor formulation comprising:
an iodine mixture;
a nonionic surfactant;
a macronutrient;
a chelated micronutrient; and
an agriculturally acceptable liquid carrier or diluent.

2. The iodophor formulation of claim 1, wherein the agriculturally acceptable liquid carrier or diluent is water.

3. The iodophor formulation of claim 1, further comprising an additive.

4. The iodophor formulation of claim 3, wherein the additive comprises a humectant, an amphoteric surfactant, or a combination thereof.

5. The iodophor formulation of claim 1, wherein the iodine mixture comprises a potassium iodide (KI) and an elemental iodine (I₂).

6. The iodophor formulation of claim 5, wherein the elemental iodine and the potassium iodide are present in a weight ratio (I₂:KI) from about 0.5:1 to about 1:1.

7. The iodophor formulation of claim 1, wherein the nonionic surfactant and the iodine mixture are present in a weight ratio from about 3:1 to 40:1.

8. The iodophor formulation of claim 1, wherein the macronutrient is present in the iodophor formulation in an amount from about 1% to about 25% by weight.

9. The iodophor formulation of claim 1, wherein the chelated micronutrient is present in the iodophor formulation from about 0.0001% to about 1% by weight.

10. The iodophor formulation of claim 1, wherein the nonionic surfactant comprises an alkyl polyglucoside, an alcohol ethoxylate, a nonylphenol ethoxylate, a polyoxyethylene sorbitan ester, a silicon based nonionic surfactant, a betaine, or any combination thereof.

11. The iodophor formulation of claim 1, wherein the macronutrient comprises any one of magnesium, calcium, nitrogen, diphosphorous pentoxide, potassium oxide, or a combination thereof.

12. The iodophor formulation of claim 1, wherein the chelated micronutrient comprises at least one of manganese, iron, zinc, copper, boron, molybdenum, or a combination thereof.

13. A method of preparing an iodophor formulation, the method comprising:
dissolving a micronutrient and a chelated micronutrient in water to prepare a nutrient solution;
dissolving potassium iodide in water and adding iodine to the potassium iodide in the water to prepare an iodine mixture;
adding a nonionic surfactant to the nutrient solution forming a nonionic surfactant nutrient solution; and
combining the nonionic surfactant nutrient solution and the iodine mixture to form the iodophor formulation.

14. The method of claim 13, further comprising adding an additive.

15. The method of claim 13, wherein temperature of the water in the dissolving the micronutrient and the chelated micronutrient step is maintained at about 40° C. to about 45° C.

16. The method of claim 13, wherein temperature of the water in the adding the nonionic surfactant to the nutrient solution step is maintained at about 30° C. to about 35° C.

17. The method of claim 13, wherein pH of the iodophor formulation is about 4 to about 8.

18. A method of increasing photosynthetic efficiency of a crop, the method comprising treating the crop with the iodophor formulation of claim 1.

19. The method of claim 18, wherein treating the crop comprises spraying the iodophor formulation onto leaves of the crop.

20. The method of claim 18, wherein the crop comprises a fruit, a grain, or a vegetable.

21. The method of claim 18, wherein the crop comprises coffee trees or citrus trees.
